(19) United States
(12) Patent Application Publication
(10) Pub. No.: US 2002/0123957 A1
(43) Pub. Date: Sep. 5, 2002

(54) Method and apparatus for marketing and communicating in the wine/spirits industry

(76) Inventors: Burt Notarius, E. Amherst, NY (US); Devendra Nayak, Burlington, MA (US); Arun Jani, Westford, MA (US); Kelly Ka Yiu Chan, Cambridge, MA (US); Paul J. Benati, Penfield, NY (US); A. Drew McNichol, Hamburg, NY (US)

Correspondence Address: SIMPSON & SIMPSON, PLLC, 5555 MAIN STREET, WILLIAMSVILLE, NY, 14221-5406, US

(21) Appl. No.: 09/929,214

(22) Filed: Aug. 14, 2001

Related U.S. Application Data
(63) Continuation of application No. 09/751,874, filed on Dec. 29, 2000.

(51) Int. Cl. G06F 17/60

(52) U.S. Cl. 705/37; 705/26

(57) ABSTRACT

A method and apparatus for marketing and communicating in the wine/spirits industry. The method of the invention includes the steps of receiving an offer from at least one wine/spirit suppliers to pay for a solicitation to at least one identified consumer of a participating retail wine/spirit establishment for a selected set of products; communicating a set of possible product offerings from the at least one wine/spirit suppliers to at least one of the participating retailers of wine/spirits, where each such set includes a number of products; receiving a communication from at least one such participating retailer agreeing to offer a subset of said set of product offerings at a sale price; analyzing information related to such subset of such set of product offerings with a computer; and, communicating such information related to such sales of such subset of such set of product offerings to an interested party.

### RELATED APPLICATION

This continuation patent application claims the benefit of U.S. application Ser. No. 09/751,874, filed Dec. 29, 2000.

### FIELD OF THE INVENTION

The present invention relates generally to the wine and/or spirits industry, and, more particularly, to a method and apparatus for marketing and communicating in the wine/spirits industry.

### BACKGROUND OF THE INVENTION

In 1919, two entire industries in the United States, the distilled spirits industry and the wine industry, were declared illegal. The Eighteenth Amendment to the Constitution, the Volstead Act, prohibited the manufacture, sale and transportation of intoxicating liquors. For the next fourteen years, suppliers, wholesalers, retailers and customers of distilled spirits and wines attempted to market, sell and purchase products behind closed doors, in darkened alleyways and in speakeasies. In 1933, Prohibition ended on a federal level in the United States with the enactment of the Twenty-First Amendment to the Constitution. The end of Prohibition did not, however, end government regulation of the industry. Rather, the regulatory structure of the industry became increasingly complex and multi-layered with federal, state and local governmental bodies passing laws and enacting regulations to control the activities of participants in both the distilled spirits and wine industries. The end result is that today, suppliers, wholesalers, retailers and customers of distilled spirits and wines are as much in the “dark” when attempting to communicate with each about marketing, selling and purchasing those products as their predecessors were during Prohibition.

The Role of Industry Participants

The roles and interactions between and among the participants in both the wine industry and the distilled spirits industry are controlled, in part, by governmental regulations on the federal, state and local levels. In the wine industry, the Federal Alcohol Agency requires that all winemakers, the suppliers, sell their products almost exclusively through various wholesalers and retailers. Certain qualifying winemakers may also sell wines. This alternative distribution channel allows vineyards to sell wine at the winery to visitors; most of whom purchase wine in connection with tours of the winery. Winemakers or suppliers must also comply with various state laws that govern the distribution of wine. Most states allow private wholesalers and retailers to function, but eighteen states control the distribution and retail of wines directly; in other words, the state government acts as both distributor and retailer through designated state stores. Private wine wholesalers and retailers are also governed by both state and local law. For example, private retailers of wine must be licensed by the state and, in many cases, by the local municipality, either county, city, town or village or a combination thereof. Finally, consumers are regulated by state and local governmental bodies which dictate age requirements for the purchase of wine, as well as, in some areas, quantity limits. The distilled spirits industry participants are controlled by similar governmental regulations throughout the distribution channel. One significant difference however is that distillers, the suppliers, can also be wholesalers.

In both industries, because of government regulations, suppliers and wholesalers are not permitted direct communication at time of purchase with consumers. Retailers are the only part of the distribution channel that are permitted direct contact with consumers at time of purchase. Retailers however, generally have little, if any, direct contact with suppliers. Instead, retailers communicate almost exclusively with one or more wholesalers. In turn, wholesalers usually communicate with numerous retailers. Thus, suppliers, wholesalers and retailers all make various and independent efforts to successfully market products to consumers without an overall coordination or assessment of their joint efforts.

Current Industry Economic Structure

The recent trend of consolidation in all aspects of both industries further complicates an assessment of effective marketing communications among the participants in both industries' distribution channels. In recent years, both industries have seen increasing supplier consolidation, becoming oligopolistic in market structure. In the distilled spirits industry, the top four suppliers account for over sixty percent of the industry's market share. In addition, based on market share statistics, two of the top four suppliers in the domestic distilled spirits industry have become two of the top three suppliers in the domestic wine industry. Thus, one supplier most often produces several competing brands of distilled spirits and wines. In addition, suppliers, in a continuing effort to push for greater economies of scale, have downsized in-house brand managers and are relying more on the efforts of wholesalers and retailers to increase product sales. Thus, one supplier brand manager may be responsible for several competing products. Consolidation has also occurred on the wholesaler level to the extent possible under law. One wholesaler often represents more than one supplier, although exclusive arrangements do exist. Only on the retail level has consolidation not occurred because of government regulation.

Consolidation has also occurred within product lines. Industry participants are concentrating their marketing and advertising dollars on the high market share brands of distilled spirits and wines. For example, in the distilled spirits industry high market share brands include Dewars, Jack Daniels, Jim Beam, Absolut, Baccardi and Tanqueray. Thus, a larger percentage of marketing and advertising resources are expended for these brands than on less well-known brands.

Current Industry Marketing and Advertising

Both industries know marketing and advertising is effective in increasing market share. Ultimately, marketing and advertising resources are targeted to the consumer. Each industry participant in the distribution channel allocates marketing and advertising resources; these resources include discount pricing, point-of-purchase advertising, as well as general market advertising. In addition, the actions of each industry participant influences the ultimate effect the marketing and advertising resources have on sales. For example, a supplier could pay for a point-of-purchase display for a product and give those displays to the wholesaler to distribute, but if the wholesaler does not distribute them or the retailer does not use the displays, the effectiveness of the displays on consumers will be non-existent.

Both industries have recognized that consumer satisfaction and manipulation of sales trends form the basis of successful marketing and advertising strategies, the question has been how to quantitatively and accurately measure each industry participants' marketing and advertising efforts and the success thereof. As one representative of the distilled spirits industry indicated in a magazine article in 1996 (Richard McGown, Government Regulation of the Alcohol Industry: The Search for Revenue and the Common Good, Quorum Books, Westpoint, Conn., 1997, pp. 87, Quoting from Beverage Industry Manual, 1996, pg. 32), sophisticated retailers, wholesalers and suppliers must be able to capitalize on consumer knowledge and develop local sales programs that cater to particularized market segments.

The issue was further complicated by the lack of adequate technology. In order to develop a sales program that catered to particularized market segments, hardware and software was needed that would allow the transfer of detailed information provided by each of the participants in the distribution channel. The transfer of this information, of course, was also constrained by regulatory issues and competitor confidentiality. Capacity was an issue because of the tremendously high volume of information from each of the parties in the distribution channel that needed to be collected, collated and analyzed. Timing was also an issue because the most crucial information, the customer information from the retailer, is updated on a daily basis. Thus, in order to effectively utilize the customer information, the transfer of information needed to occur in a high speed, quickly updateable format.

Heretofore, there has been a longfelt need in both the distilled spirits and the wine industry for a method and apparatus to provide high speed, high capacity information transfer amongst all the participants in the distribution channels of each industry that complied with the regulatory structure and respected competitor confidentiality. In addition, after the information was collected and collated, a quantitative analysis of all the information relevant to the marketing and selling of the industries products, particularly the detailed customer information, needed to be done in a manner that enabled the participants to develop local sales programs that catered to particularized market segments.

### SUMMARY OF THE INVENTION

The present invention comprises a method and apparatus for marketing and communicating in the wine/spirits industry. The method of the invention includes the steps of receiving an offer from at least one wine/spirit suppliers to pay for a solicitation to at least one identified consumer of a participating retail wine/spirit establishment for a selected set of products; communicating a set of possible product offerings from the at least one wine/spirit suppliers to at least one of the participating retailers of wine/spirits, where each such set includes a number of products; receiving a communication from at least one such participating retailer agreeing to offer a subset of said set of product offerings at a sale price; analyzing information related to such subset of such set of product offerings with a computer; and, communicating such information related to such sales of such subset of such set of product offerings to an interested party.

A general object of the invention is to provide a method and apparatus for communicating and marketing in the wine/spirit industry. This and other objects, features and advantages of the invention will become apparent upon reading the following detailed description, appended claims and drawings.

### BRIEF DESCRIPTION OF THE DRAWINGS

FIG. 1 is a functional context diagram which provides a summary of the feeds and interfaces between various application and business model elements of the present invention;

FIG. 2 illustrates the application integration model of the present invention;

FIG. 3 illustrates portal views of the present invention;

FIG. 4 illustrates the web traffic analysis cycle of the present invention;

FIG. 5 illustrates data flow between applications of the invention;

FIG. 6 illustrates product mapping of the invention;

FIG. 7 illustrates the development and QA LAN setup of the invention;

FIG. 8 is a hardware configuration of the present invention in a preferred embodiment;

FIG. 9 illustrates an architecture of a preferred embodiment of the present invention;

FIG. 10 illustrates outsourced clients Mail Store;

FIG. 11 illustrates components for outbound mail campaigns;

FIG. 12 illustrates Oracle iStore architecture, used in a preferred embodiment of the present invention;

FIG. 13 illustrates Oracle Portal architecture, used in a preferred embodiment of the present invention; and,

FIG. 14 illustrates Oracle Warehouse Builder architecture, used in a preferred embodiment of the present invention.

### DETAILED DESCRIPTION OF THE PREFERRED EMBODIMENT

Introduction

The present invention comprises a method and apparatus for marketing and communication in the wine/spirits industry. It should be appreciated that, in a preferred embodiment the invention pertains to the wine/spirits industry, but the invention described and claimed herein could be applied to other industries and products as well (e.g., confectionery, cigars, beer, food, flowers, coffee, cheese, jewelry, automobiles, and other industries and products not listed here.) The following detailed description includes architectural approaches, components (hardware, software and network) and operations to support the business model of the invention. In the description that follows, the apparatus of the invention is referred to as a Channel Hub Network, and the Channel Hub is envisioned to be both a business entity in a business model, as well as a hub in a computer network.

In the detailed description which follows, the following definitions apply:

Definitions

Disclaimer: The following definitions have been constructed for purposes of the patent application. Many of the definitions parallel the various federal, state, and local statutes and regulations governing the Distilled Spirits and Wine Industries. If any of the definitions do not conform with the various federal, state, and local statutes and regulations governing the Distilled Spirits and Wine Industries, these definitions should not be used as evidence of non-compliance with the various federal, state, and local statutes and regulations governing. Applicant plans to comply with all appropriate federal, state and local statutes and regulations pertaining to its business and the business of participants in the distribution channels.

All terms which are combinations of defined terms shall be defined as the natural combination of the two already defined terms. For example, Retailer's Address Information shall mean Address Information for a Retailer.

ADDRESS INFORMATION: All information related to any method of contacting or communicating with a person or an entity. This information shall include, but not be limited to, a street address, city, town or village, county, state, country, zip code or postal code, telephone number, telefax number, and electronic mail or e-mail address.

ADDRESS PROFILE INFORMATION: All Address Information related to the distribution of any Product in the Distilled Spirits Industry or the Wine Industry and analysis thereof. Such information shall include, but not be limited to, Supplier Address Information, Wholesaler Address Information, Retailer Address Information, and Customer Address Information.

ADVERTISING INFORMATION: All information related to any advertisements, whether in/on print, television, other types of video, radio, other types of audio, digital, electronic or any other form, for any Product regardless of the source of payment or sponsorship for the advertisement. Such information shall include, but not be limited to, the date the advertisement ran, the type of media in which the advertisement ran, the length of time the advertisement ran, the contents of the advertisement, the Products contained in the advertisement, whether or not the Products contained in the advertisement were Product in an Offer, the cost of the advertisement, the name of the party(ies) who paid for the advertisement, the role of the party(ies) who paid for the advertisement, if any, in the Distribution Channel, the role of the Channel Hub, if any, in the advertisement and any related Display Location Information and Display Location Profile Information.

ADVERTISING PROFILE INFORMATION: All Advertising Information related to the distribution of any Product in the Distilled Spirits Industry or the Wine Industry and analysis thereof. Such information shall include, but not be limited to, Supplier Advertising Information, Wholesaler Advertising Information, Retailer Advertising Information and Address Profile Information.

CHANNEL HUB: The channel hub is a node in the Channel Hub Network comprised of a computer or a series of computers, run on the Channel Hub Network software, which serves as a clearinghouse for all Information, a processing center for analysis of all the Information and a communication center for disseminating all the Information to other participants in the Channel Hub Network. It may also be used to describe an entity charged with the operation and maintenance of the Channel Hub.

CHANNEL HUB NETWORK: A Channel Hub Network is a computer based information/marketing network comprised of the Channel Hub and any and all Participating Parties of the Distribution Channel and such computers as the Participating Parties use to access Information, transmit Information, send Communications, or receive Communications from other Participating Parties.

COMMUNICATION: Any transmission of Information, including but not limited to a transmission by regular mail, electronic mail, courier, telefax or telephone, in any form, including but not limited to digital, electronic or written form.

CONSUMER: see Customer

CUSTOMER: Any natural person, of legal age in the jurisdiction of purchase, who purchases Distilled Spirits or Wine for personal consumption or personal use. A consumer shall not include any entity that purchases Distilled Spirits or Wine for resale. May also be described as a Consumer or a Retail Customer.

CUSTOMER INFORMATION: All information concerning or related to a particular, identifiable, Customer, a particular group of Customers or any compilation thereof. This information shall include, but not be limited to the Customer's name, the Customer's identification number, the Customer's driver's license (in scanable format), the Customer's driver's license number, other proof of age documentation for the Customer, the Customer's Address Information, the Customer's education level, the Customer's income level, the Customer's family structure, the Customer's hobbies or interests and any other demographic information for the Customer.

CUSTOMER PROFILE INFORMATION: All information relating to Customer Information, Address Profile Information and any analysis thereof.

CUSTOMER'S PURCHASING HISTORY INFORMATION: This information shall be all information concerning a Customer or any group of Customers or any compilation thereof and relating to all Sales Transactions by that Customer or group of Customers or any compilation thereof involving any Product. This information shall include but not be limited to all Customer Information and Sales Transaction Information.

CUSTOMER'S PURCHASING HISTORY PROFILE INFORMATION: This information shall be all information relating to Customer Purchasing History Information, Address Profile Information and the analysis thereof.

DISCOUNT PRICE: Any Product price which is lower than the previous quoted Product price. May also be referred to as the Sale Price.

DISPLAY LOCATION INFORMATION: All information related to any point of purchase advertising materials, in any media, including but not limited to print, television, other types of video, radio, other types of audio, digital, electronic or any other form, for any Product displayed in a Retail Wine/Spirit Establishment. Such information shall include, but not be limited to, the date the point of purchase advertising materials were displayed, the type of the media which displayed the point of purchase advertising materials, the length of time the point of purchase advertising materials were displayed, the contents of the point of purchase advertising materials, the Products contained in point of purchasing advertising materials, the cost of the point of purchase advertising materials, the name of the party(ies) who displayed the point of purchase advertising materials, the name of the party(ies) who paid for the point of purchase advertising materials, the role of the party(ies) who paid for the point of purchase advertising materials in the Distribution Channel, the location of the display of the point of purchase advertising materials within the Retail Wine/Spirit Establishment, the Retailer's Address Information, and the role of the Channel Hub, if any, in the point of purchase advertising materials.

DISPLAY LOCATION PROFILE INFORMATION: This information shall be all information relating to Display Location Information and the analysis thereof.

DISTILLED SPIRITS: Ethyl alcohol, hydrated oxide of ethyl, spirits of Wine, whisky, rum, brandy, gin, and other distilled spirits, including all dilutions and mixtures thereof, for non-industrial use. May also be referred to as simply “Spirits”. The term “Distilled Spirits” and/or “Spirits” shall not include mixtures containing Wine, bottled at 48 degrees of proof or less, if the mixture contains more than 50 percent Wine on a proof gallon basis.

DISTILLED SPIRITS INDUSTRY: The overall economic and business structure involved in the production, distribution, sale and purchasing of Distilled Spirits, including but not limited to all parties in the Distribution Channel.

DISTRIBUTION CHANNEL: All of the parties in the distribution of Distilled Spirits or Wine and all the parties in the Distilled Spirits Industry or Wine Industry, including but not limited to Suppliers, Wholesalers, Retailers, and Customers.

GEOGRAPHIC PROFILE INFORMATION: See Address Profile Information

INFORMATION: Information includes all Address Information, Address Profile Information, Advertising Information, Advertising Profile Information, Customer Information, Customer Profile Information, Customer's Purchasing History Information, Customer's Purchasing History Profile Information, Display Location Information, Display Location Profile Information, Inventory Information, Inventory Profile Information, Product Production, Product Profile Information, Promotional Information, Promotional Profile Information, Retailer Information, Retailer Profile Information, Sales Transaction Information, Sales Transaction Profile Information, Supplier Information, Supplier Profile Information, and Wholesaler Information, Wholesaler Profile Information.

INTERESTED PARTY: see Participating Party

INVENTORY INFORMATION: All information related to the inventory of any Product held by a Supplier, Wholesaler, or Retailer, any grouping of Suppliers, Wholesalers or Retailers and compilation thereof. Such information shall include, but not be limited to, the date of purchase of the Product, the name of the party(ies) from whom the Product was purchased, the purchase cost of the Product, the name of the party(ies) who currently owns the Product, the quantity of the Product currently held by a Supplier, Wholesaler, or Retailer or grouping thereof, the shelf life of the Product, the Display Location Information associated therewith, and the Display Location Profile Information associated therewith.

INVENTORY PROFILE INFORMATION: All Inventory Information, Address Profile Information and the analysis thereof.

PARTICIPATING PARTY: The Channel Hub and/or any party in the Distribution Channel who becomes a member of the Channel Hub Network or agrees to participate in the Channel Hub Network. See also Participating Wholesaler, Participating Supplier and Participating Retailer.

PARTICIPATING RETAIL WINE/SPIRIT ESTABLISHMENT: See Participating Retailer

PARTICIPATING RETAILER: A Retailer that has signed a membership agreement with the Channel Hub to participate in the Channel Hub Network. May also see be referred to as a Participating Retail Wine/Spirit Establishment.

PARTICIPATING SUPPLIER: A Supplier that has signed an agreement with the Channel Hub to participate in the Channel Hub Network.

PARTICIPATING WHOLESALER: A Wholesaler that has signed an agreement with the Channel Hub to participate in the Channel Hub Network.

PRODUCT: Any Distilled Spirits or Wine.

PRODUCT INFORMATION: All information concerning or related to a particular and identifiable Product, or a particular and identifiable group of Products or any compilation thereof. Such information shall include, but not be limited to, the type of Product—such as whisky, Bordeaux, etc., the region of the Product, the alcohol content of the Product, the Supplier of the Product and all related Supplier Information, the Wholesaler of the Product and all related Wholesaler Information, the purchase price of the Product, the Discount Price of the Product, whether or not the Product is part of a Product Offering, a typical customer of the Product, rating and review information on the Product, information on economic substitutes or related goods of the Product and all related Advertising Information, Advertising Profile Information, Display Location Information, Display Location Profile Information, Inventory Information, Inventory Profile Information and Retail Store Mapping.

PRODUCT PROFILE INFORMATION: All information concerning or related to a particular and identifiable Product, a particular and identifiable group of Products or any compilation thereof, all Address Profile Information and the analysis of all such information.

PROMOTIONAL INFORMATION: All information related to any and all Offerings of Product, including any subset thereof. Such information shall include, but not be limited to, all Advertising Information, Advertising Profile Information, Customer Information, Customer Profile Information, Customer's Purchasing History Information, Customer's Purchasing Profile Information, Inventory Information, Inventory Profile Information, Product Information, Product Profile Information, Retailer Information, Retailer Profile Information, Sales Transaction Information, Sales Transaction Profile Information, Supplier Information, Supplier Profile Information, Wholesaler Information and Wholesaler Profile Information.

PROMOTIONAL PROFILE INFORMATION: All information related to all Offerings of Product, including any subset thereof, and all analysis of such information.

PERFORMANCE ANALYSIS: The analysis of any Information including but not limited to comparative analysis, ranking analysis, quantitative analysis, econometric analysis, statistical analysis or any other method of analysis. Such as Performance Analysis of Promotional Information.

RETAIL CUSTOMER: see Customer

RETAIL SALES TRANSACTION INFORMATION: See Sales Transaction Information

RETAIL WINE/SPIRITS ESTABLISHMENT: See Retailer

RETAILER: Any entity that is licensed according to all applicable federal, state and local laws and regulations to sell or offer for sale Products to Customers. May also be referred to as a Retail Wine/Spirit Establishment.

RETAILER INFORMATION: All information concerning or related to a particular and identifiable Retailer, a particular and identifiable group of Retailers or any compilation thereof. This information shall include, but not be limited to the Retailer's name, the Retailer's identification number, the Retailer's Address Information, the Retailer's Advertising Information, the Retailer's Advertising Profile Information, the Retailer's Customer Information from the Retailer's Customer list or database, all related Customer Profile Information, the Retailer's Inventory Information, the Retailer's Inventory Profile Information, the Retailer's Product Information, the Retailer's Product Profile Information, the Retailer's Sales Transaction Information, the Retailer's Sales Transaction Profile Information and the Retailer's Store Mapping.

RETAILER PROFILE INFORMATION: All Retailer Information, Address Profile Information and the analysis thereof.

RETAIL STORE MAPPING: A floor plan diagram of the location of all Products in a Retail Wine/Spirit Establishment.

SALE PRICE: see Discount Price

SALES TRANSACTION INFORMATION: This information shall be all information concerning a retail sale of Product or any grouping of retail sales of Product and compilation thereof. This information shall include but not be limited to credit card type, credit card numbers, credit card expiration dates, Product purchased, quantities of Product purchased, dates of Product purchase, point of sale transaction information for each Product purchase, gift ordering, location and method of Product purchase, method of payment for Product purchase, and all related Advertising Information, Advertising Profile Information, Customer Information, Customer Profile Information, Product Information, Product Profile Information, Retailer Information and Retailer Profile Information. May also be referred to as Retail Sales Transaction Information.

SALES TRANSACTION PROFILE INFORMATION: All Sales Transaction Information and the analysis thereof.

SPIRITS: see Distilled Spirits

SUBSET: At least one Product from an Offering of Products

SUPPLIER: An entity that is licensed according to all applicable federal, state and local laws and regulations that either directly or indirectly, though sub-distillers or sub-vintners who are also licensed, distills or otherwise creates any Distilled Spirits and/or Wine. May also be referred to as either a Distilled Spirits Supplier or a Wine Supplier.

SUPPLIER INFORMATION: All information concerning or related to a particular and identifiable Supplier, or a particular and identifiable group of Suppliers or any compilation thereof. This information shall include, but not be limited to the Supplier's name, the Supplier's identification number, the Supplier's Address Information, the Supplier's Advertising Information, the Supplier's Advertising Profile Information, the Supplier's Inventory Information, the Supplier's Inventory Profile Information, the Supplier's Product Information and the Supplier's Product Profile Information.

SUPPLIER PROFILE INFORMATION: All Supplier Information, Address Profile Information and the analysis thereof

WHOLESALER: An entity that is licensed according to all applicable federal, state and local laws and regulations to sell or offer for sale to a Retailer Distilled Spirits and/or Wine. May also be referred to as either a Distilled Spirits Wholesaler, or a Wine Wholesaler.

WHOLESALER INFORMATION: All information concerning or related to a particular and identifiable Wholesaler, or a particular and identifiable group of Wholesalers or any compilation thereof. This information shall include, but not be limited to the Wholesaler's name, the Wholesaler's identification number, the Wholesaler's Address Information, the Wholesaler's Advertising Information, the Wholesaler's Advertising Profile Information, the Wholesaler's Inventory Information, the Wholesaler's Inventory Profile Information, the Wholesaler's Product Information and the Wholesaler's Product Profile Information.

WHOLESALER PROFILE INFORMATION: All Wholesaler Information, Address Profile Information and the analysis thereof.

WINE: Wine includes any of the following: (a) any natural wine which is a product of the juice or must of sound, ripe grapes or other sound, ripe fruit, made with any authorized cellar treatment and containing not more than 21 percent by weight of total solids, (b) any specially sweetened natural wine which is the product made by adding to natural wine of the winemaker's own production a sufficient quantity of pure dry sugar, or juice or concentrated juice from the same kind of fruit, separately or in combination, to produce a finished product having a total solids content in excess of 17 percent by weight and an alcoholic content of not more than 14 percent by volume, and shall include extra sweet kosher wine and similarly heavily sweetened wines, (c) any special natural wines which are the products made, pursuant to an approved formula, from a base of natural wine (including heavy-bodied blending wine) exclusively, with the addition, before, during or after fermentation, of natural herbs, spices, fruit juices, aromatics, essences, and other natural flavorings in such quantities or proportions as to enable such products to be distinguished from any natural wine not so treated, and with or without carbon dioxide naturally or artificially added, and with or without the addition, separately or in combination, of pure dry sugar or a solution of pure dry sugar and water, or caramel, (d) any standard agricultural wine, (e) any heavy bodied blending wine which is a product made from fruit without added sugar, and with or without added wine spirits, and conforming to the definition of natural wine in all respects except as to maximum total solids content, or (f) any other alcoholic beverage not so defined, but made in the manner of wine, including sparkling and carbonated wine, wine made from condensed grape must, wine made from other agricultural products than the juice of sound, ripe grapes, imitation wine, compounds sold as wine, vermouth, cider, perry, and sake; in each instance only if containing not less than 7 percent, and not more than 24 percent of alcohol by volume, and if for non-industrial use.

WINE INDUSTRY: The overall economic and business structure involved in the production, distribution, sale and purchasing of Distilled Spirits, including but not limited to all parties in the Distribution Channel.

In a preferred embodiment, the present invention performs a number of functions, and includes a number of features, including some not described in the appended claims. A listing of some of these features and functions is presented herebelow, organized by Strategic Process:

Registration and Setup

1. Register, collect and maintain retail store consumer information and profile.

2. Register retailers into the Channel Hub Network.

3. Register suppliers into the Channel Hub Network.

4. Register wholesalers into the Channel Hub Network.

5. Validate a user's identity by e-mail address/password combination and authorize privileges to the Channel Hub Network.

6. Validate a user's identity by card number/last name/phone number combination and authorize privileges to the Channel Hub Network.

7. Provide a user with a Channel Hub e-mail address.

8. Enable customers to maintain a list of favorite products, to rate or to review products and to see past product ratings or reviews.

9. Enable customers to view and select tailor-made promotions.

10. Enable customers with a calendar to plan events and/or purchases online.

11. Enable Channel Hub to remind customers of events of interest.

Order Management

1. Provide a mechanism for consumer to search on products.

2. Provide a process for consumers to place items into a shopping cart.

3. Provide a process for consumers to place orders online.

4. Provide a mechanism for Channel Hub, suppliers, retailers, and consumers to check inventory levels.

5. Enable customers to see order histories.

6. Manage customer loyalty programs and incentive sales programs.

Marketing and Sales Management

1. Manage promotions, events and campaigns effectively to drive repeat business and overall volume.

2. Provide Channel Hub, suppliers, and retailers with capabilities to report on business activities.

3. Recommend and communicate products to customers based on past orders/ratings.

4. Manage promotional artwork.

5. Enable Channel Hub to send members a “Thank You” e-mail (or other e-mail messages) for purchasing a product at the retail store.

6. Offer product brokerage services for suppliers by using Channel Hub's substantial buying power and distributor network.

Catalog Management

1. Provide a process for retailers to update product catalog information.

2. Provide a process for suppliers to update promotions catalog information.

Channel Hub Operations

1. Enable Channel Hub to generate bills/invoices to retailers, suppliers and wholesalers and to handle collection of payments via paper mailings or online/electronic payments (Internet and/or EFT—electronic funds transfer).

2. Enable Channel Hub to maintain web site.

3. Enable Channel Hub to maintain the Terms & Conditions for its clients.

4. Enable Channel Hub to record and process financial transactions and to produce financial reporting.

5. Enable mechanism to produce payments to vendors and suppliers for purchases of goods and services. Provide means to submit, approve and pay employee expense reimbursement.

Customer Service

1. Provide online support to all functionality within Channel Hub infrastructure.

2. Provide static demonstration of all Channel Hub functionalities.

3. Provide online review and explanation of bills that are sent to suppliers and retailers.

Community Tools

1. Provide news or reviews pertaining to wines and spirits to all Channel Hub customers.

2. Provide event planning advice, recipes and other learning material to customers.

3. Enable users to e-mail a particular page to a friend.

4. Provide an off-line bulletin board style communication between users.

5. Provide online chat platform for customers.

6. Enable customers to form online tasting groups similar to message boards.

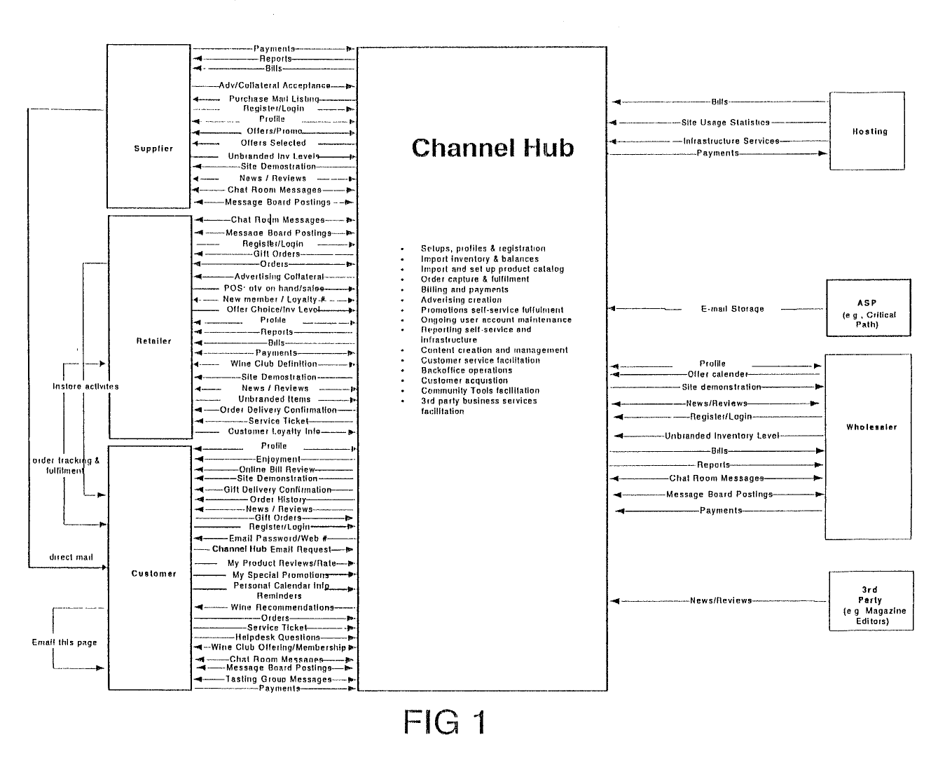

FIG. 1 is an illustration of the apparatus of the Channel Hub Network (10), which generally comprises Channel Hub (11), Supplier (12), Retailer (13), Customer (14), Third Party (15), Wholesaler (16), Application Service Provider-ASP (17), and Host (18). The Channel Hub Network (10) provides a means by which its constituents may communicate and exchange information via the Channel Hub (11), or with one another.

Communication occurs in the following manner:

1. In the context of Supplier (12), Channel Hub Network (10) allows one-way communication of Payment, Advance/Collateral Acceptance, Register/Login, and Unbranded Inventory Level information from Supplier (12) to Channel Hub (11). Similarly, the Channel Hub Network (10) allows the transfer of one-way Report, Bill, Purchase Mail Listing, Offer Selection, and Site Demonstration information from Channel Hub (11) to Supplier (12). The Channel Hub Network (10) also allows the bi-directional communication of information pertaining to Profiles, Offers/Promo's, News/Reviews, Chat Room Messages, and Message Board Postings between the Channel Hub (11) and Supplier (12), or the Supplier (12) and the Channel Hub (11).

2. In the context of Retailer (13), the Channel Hub Network (10) allows Retailers (13) to communicate one-way Register/Login, POS: Quantity on Hand/Sales, Offer Choice/Inventory Levels, Unbranded Items, and Customer Loyalty information to the Channel Hub (11). The Channel Hub (11) communicates one-way Gift Order, Advertising Collateral, Report, Bill, Site Demonstration, Order Delivery Confirmation and Service Ticket Information to Retailers (13). Both Retailer (13) and Channel Hub (11) share, bi-directionally, Chat Room Message, Message Board Posting, Order, New Member/Loyalty #, Profile, Payment, Wine Club Definition and News/Review information with one another.

3. In the context of Customer (14), the Channel Hub Network (10) allows the one-way communication of information related to Gift Orders, Register/Login, WineISIT email Requests, My Product Reviews/Rate, My Special Promotions, Personal Calendar Info reminders, Orders, Service Ticket, Helpdesk Question, and Payments from Customer (14) to Channel Hub (11). In contrast, Enjoyment, Online Bill Review, Site Demonstration, Gift Delivery Confirmation, Order History, News/Review, email Password/Web #, and Wine Recommendation information is one-way communicated from Channel Hub (11) to Customer (14). Bi-directional sharing of information between Channel Hub (11) and Customer (14) concerns Profile, Wine Club Offering/Membership, Chat Room Message, Message Board Posting, and Tasting Group Message information.

4. With relation to Wholesalers (16), the Channel Hub Network (10) facilitates the one way- exchange of Offer Calendar, Register/Login, Un-branded Inventory Level, and Payment information from Wholesaler (16) to Channel Hub (10). Similarly, one-way information pertaining to Site Demonstration, Bill, and Report information is transferred from Channel Hub (11) to Wholesaler (16). Bi-directional sharing of Profile, Chat Room Messages, and Message Board Postings between Wholesaler (16) and Channel Hub (11) is provided through the Channel Hub Network (10).

5. The Channel Hub Network (10) also allows Third Parties (15) to submit News/Review information to the Channel Hub (11), allows ASP's (17) to send email storage information to the Channel Hub (11), allows Hosts (18) to send Bill, Site Usage Statistics and Infrastructure Service information to the Channel Hub (11), and allows the Channel Hub (11) to send Payment information to Hosts (18).

6. Finally, the Channel Hub Network (11) allows Direct Mail one-way communication from Supplier (12) to Customer (14), one-way communication of In-store Activities from Retailer (13) to Customer (14), two-way communication of Order Tracking and Fulfillment information between Retailer (13) and Customer (14), and allows Customers (14) to email one another.

The conceptual functional architecture of the Channel Hub Network is described as follows. The invention includes several functional areas required to operate the Channel Hub Network. These functional areas are built up from strategic initiatives and processes identified and detailed previously. There are three main functional areas in the model: Platform Services, Hosting Services and Front-End Content Services, described seriatum herebelow:

Platform Services

Platform services encompasses the entire stack of functionality required to make the Channel Hub Network operative. Within the platform services area are the following:

1. Front-End Content Services

This section represents items such as news feeds, general content, and links to other partner sites such as Community Tools, Financial Institutions and Business Services.

2. Application Services

This section encompasses the following:

Services

This cluster represents the high-level functional requirements of the Channel Hub Network. It represents the integration of different software components for seamless deployment as the Channel Hub Network. Services provided include, but are not limited to: Registration and Profile, Orders, Inventory Management, Community Tools, Business Services, Wine Clubs, Pricing, Campaign Management, Product & Promotion Catalog and Product Brokerage Services.

Channel Hub Back Office

This represents the back-office functions of Channel Hub as an organization. This includes the implementation of a revenue model and associated billing, financial accounting systems, and ongoing site maintenance. Back Office services include, but are not limited to: Content Management, Procurement, Financials & Accounting, Human Resources & Payroll, Revenue Model & Billing and Site Management & Maintenance.

Front-Line Services

These elements represent typical Customer Relationship Management (CRM) applications for customer service and marketing and sales force automation. These services include, but are not limited to: Marketing & Sales Support and Customer Support.

Market Intelligence

This section includes various aspects of market intelligence, including, but not limited to: Order History, Promotion History, OLAP and Data Mining.

3. Data Services

In a preferred embodiment, these do not represent individual databases (although they could in another embodiment). These are the major data sets that are stored by the Channel Hub. These data sets include, but are not limited to, Members, Product Catalog, Inventory, Operational Data, Data Warehouse, Conversion Repository and Promotion Artworks. The data is accessible by various tools and applications but will be secured as appropriate.

4. Enterprise Integration Services

These services represent complete integration by external entities and systems with the Channel Hub Network. These services include, but are not limited to: Community Tools Provider, Business Services, Customer Services, Financial Institution and Point of Sale.

Hosting Services

These are included to indicate that the functional stack represented by Platform Services is hosted by third party providers. The providers are hosts of the Network without being a part of it.

Customers

Customers interact with the Channel Hub Network. In a preferred embodiment, customers include, but are not limited to: consumers, retailers, wholesalers, suppliers, community tools partners, customer service partners, and Channel Hub employees.

Solution Footprint

The Solution Footprint describes the system functions performed by the Channel Hub to meet the business requirements identified by the functional architecture. The Footprint is split into layers that represent the overall solution stack for the Network. The various layers are described seriatum herebelow:

Customers & Business Partners

This layer represents the customers of the Channel Hub. It shows the customer types, how they access the application, and which tools they use. The customer types depicted indicate that a Business-to-Business (B2B) model is supported with variations to a Business-to-Consumer (B2C) model specific to orders in addition to a data warehouse. All customers use the application interactively through a web browser. This layer also represents partners such as business partners, payment processors for bills that are integrated as part of the total solution. This layer also illustrates how customers access the application, e.g., via a portal service, standard ISP service, or any other special arrangement.

Partners can also be considered customers. Financial Institutions are a prime example of such a partner. Financial institutions provide backing for the business transactions conducted by the retailers, wholesalers and suppliers at Channel Hub, establish and monitor the credit limits and payment details for Channel Hub.

Business partners also provide digital content to the sites including product catalog and other supporting content (e.g., product editorials, promotions and artworks, etc.). Partners may also interact with the Channel Hub front-office components to manage merchandising or to run reports about retailers, order and traffic activities. Bi-directional exchange of data between Channel Hub and the business partners are supported by the Integration Layer components.

Affiliate web sites such as Community Tools portals and Business Services ASPs provide referrals/direct customer orders to the Network.

External Systems

This layer represents the external systems that are integrated as part of the total solution. Integration is with a variety of partners. Partners place their product catalogues into the Network, as well as create a particular look and feel for their catalogues and maintain that catalogue on an ongoing basis.

In a preferred embodiment, Channel Hub requires the integration of a Financial Clearing House to fulfill services made within the Network (e.g., payment settlements with retailers, wholesalers and suppliers).

Batch-process integration with point-of-sale (POS) systems of the retailers is of significant importance for Channel Hub. In a preferred embodiment, these retailers comply with the POS format set by Channel Hub (e.g., formats for prices and inventories). Integration involves mapping each partner's data into a repository of the Network with conversion into an XML format.

In a preferred embodiment, Channel Hub requires the outsourcing of a e-mail storage facility for clients at Channel Hub.

Networking & Communications Services

This layer depicts the major technical architecture components associated with networking, access and communication services. This layer illustrates the interaction between Channel Hub and customers and business partners. The customer layer interfaces via the Internet/Extranet/Intranet (i.e., via a global information network). Business partners (i.e., integrators) often interface via other secured gateway mechanisms.

Security Services

This layer depicts the major technical architecture components associated with security services of authentication and authorization. This is where Channel Hub implements security measures to protect secure valuable data (e.g., customer profiles, sales and marketing information).

Integration Services

This layer represents integration components required to integrate all applications, data and accesses to the Network solution as a whole. This is the foundation infrastructure of the overall solution.

This integration layer includes both hardware and software (i.e., Internet middleware) that enables interfacing with the outside world including all customers and business partners, accounts receivable, general ledger, accounts payable, catalogues, content, news feeds, orders and requests, etc. The integration components control the definition, flow formatting, reporting, security and auditing of all incoming and outgoing documents and transactions.

Specifically, this layer includes application servers, web servers and integration servers. The application server provides an open, distributed integration framework. Application Servers provide services to “glue” the Network components including integration with the Web Server, Session and State Management, Security Services (Authentication and Authorization), Load Balancing, Caching, Auditing and Logging of events. Hence, the application server acts as the glue for the Network Logic layer by providing all common infrastructure components for the solution.

The integration server is responsible for providing the integration backbone for the solution within and without the enterprise boundaries.

This layer includes technologies such as file transfer, data transfers, push/pull and messaging technologies, queuing technology. The integration layer calls for a server solution that provides open API's and adapters (typically written in Java) for easy integration with both internal and external application modules.

All systems within the Network layer will be protected by Firewall's (i.e., FireWalled Gateways) to ensure systems are protected against attacks from hackers.

Application Business Logic

This layer represents the high level functions performed by the Network application. These functions include, but are not limited, to the following:

Catalog Management

This component supports the creation, organization, maintenance and publishing of product related content. It also includes defining product cross-sell/up-sell relationships, product bundles, and assisting in the setup of business rules. Pricing and inventory are also components of the catalog management of the site.

Shopping Cart/Order Aggregation

This component provides the customer with the ability to browse the web site and collect items into a virtual shopping cart which can then be updated and finally “checked out” when the customer desires. The shopping cart is persistent so customers can continue a shopping session at a later date if needed. The cart tracks information about the order such as product, UPC, price and any coupons or promotions. Saved shopping lists can be used for repeat buys for store customers.

Order Status/Purchase History

This component supports customer self-service inquiries about their orders including their status, shipping and payment information (without prices). It also provides purchase history information.

Order Processing

This component interfaces with the back-end data warehouse to retrieve inventory management information and processes the order by delivering the information to the retailers for fulfillment.

Club Membership

Users may join clubs to receive special privileges or perpetual orders on a predefined periodic basis. In a preferred embodiment, the management of the club and its membership are maintained locally.

Product Brokerage Services

Product Brokerage Services provide a channel or workflow for negotiations and product exchanges between different parties of the system. It defines the brokerage process, provides different parties with online tools and creates automated notifications and alerts triggered by specific events.

Personalization and One-to-One (1: 1) Marketing

Personalization and One-to-One marketing features allow the Channel Hub site to interact with an individual customer on a one to one basis by customizing portions of the delivered site content. This technique allows a site to direct messages to the customer based on their known interests and buying history. Typically, this is achieved by collecting information about the customer such as their buying patterns and other relevant demographic information (e.g., age, gender, geography, etc.).

In a preferred embodiment, the Channel Hub site identifies a customer via a login and then tailors the presentation based on the customer's profile. The software uses customer preferences and buying history to target delivery of the product catalog (i.e., which items to display) and provide targeted promotions (e.g., coupons, sale items). A customer profile is used to expedite the ordering process by remembering the customer's preferred shipping methods and credit card information.

One-to-one marketing also includes cross-selling, which is the ability to correlate catalog items. A cross-selling application might compare two products or it might recommend another product such as a printer cable when the user selects a printer. Product cross-selling functionality can be implemented in the shopping cart or somewhere else in the site.

Software components use various techniques to find patterns within similar groups of customers and use that to target products to these customers. These recommendations can be based on the fact that certain products may be attractive to certain groups of individuals. Other techniques include product community rating, click-stream observation, rule-based matching, attribute searches, customer profile preferences, etc.

Merchandising & Promotions Management

This component is built on top of the generic Content Management component and supports the definition, setup and management of business rules, content targeting rules, promotions and incentives (e.g., coupons) merchandising functions of the site. Cross-sell, up-sell, bundling, and product comparisons are also be part of this component. In a preferred embodiment, advertising and business managers from Suppliers work with Channel Hub Operations to create their specific business rules, customer profiles and process-based flows.

HTML Templates Content Management

This includes the ability to create, syndicate, categorize (i.e., apply taxonomy), edit, route, approve, version, preview, stage, publish and retire/archive site content. In this context we exclude online product catalogs and business rules required to manage the site as these are covered by more specialized content management described infra.

Content can take the form of ads, promotions, customer targeted messages, newsgroups, editorials, buyer feedback and ratings and can assume the form of text, image, sound, video, e-mail, etc.

Technical content developers and web authors have created HTML templates. These templates include business logic objects and are parsed by the Application Server template engines to dynamically produce the web pages seen by the site customers. Templates require their own content management workflow (i.e., multi-step workflow including creation, editing, routing, testing, version control, staging, deployment and archival).

Content Exchange & Collaboration

This component provides manual and automatic exchange content with external content providers and partners (i.e., content syndication). Content exchange are secure data feeds into the company content management systems. Exchange also includes manual web-based tools used by content publishers.

Contracts Management

This component provides the system a management tool for contracts, including terms and conditions, for each of its clients. It functions in auditing clients for their compliances with the predefined terms and conditions on a periodic basis.

Customer Registration and Profile Management

This is the site component that deals with registered customers and their profiles. Customer profiles hold special information about a customer such as its name, address book (billing and delivery), payment information (payment type and number), e-mail address, shipping and handling preferences for suppliers, (e.g. overnight, 2^{nd} day air) as well as all other custom defined profile data which will assist the site content management and personalization. Profiles are accessible and updateable by customers and site managers. Profiles also include information about the customer type and affiliation for merchandising. Customers might be anonymous (i.e., guests) or registered (including subscription-based customers). In a preferred embodiment, registered customers are associated with special types and are profiled differently. Registered customers can look at their purchase history and status their orders. Customer profiles are linked to special one-to-one marketing programs and promotions. In a preferred embodiment, a membership service differentiates and supports registered customers.

Site Management & Reporting

This component manages store-wide aspects such as payment methods, shipping and handling options, store address information, security access to the store, etc. It also includes self-service reporting functions.

eCommunity Services & Message Boards

eCommunity services include components that enhance the customer experience with community tools such as message boards, chat, tasting groups, etc.

Self-Service Web Customer Care

Customer service based on web forms for customer self-service inquires. Customer self-service may include searches of the site's knowledge database, order status checks, shopping questions, and order cancellation/return (RMA) requests.

Web Site Authoring & User Experience

The tools and processes to gather requirements for the site, its creation, publishing and maintenance. HTML Authoring tools (e.g., Macromedia Dreamweaver, Microsoft FrontPage, Allaire Home Site) are used to create and maintain the web site, including storyboards, HTML templates, site hierarchy, images, etc. In a preferred embodiment, the tools are integrated with the Content Management components to automate the integration of store content, e.g., dynamically generated links, frames, etc.

Application Component Design & Development

This section includes Java tools and development environments required to design, create and deploy new custom site components

Notification & Alerts

This component provides notification of events to interested constituents. A messaging component is also important as a means of providing a communication mechanism for promotion, campaigns, order confirmation and order status messages, etc. Messaging is also important in the back-office systems. In a preferred embodiment, alerts and notifications are integrated with e-mail as well as personalization agents to display specific messages to customers on the web site.

Calendaring and E-mail Hosting

This component includes web-based e-mail and calendar services allow users to send and receive e-mail, plan and view events.

Intranet & Extranet Workflow Engine

The workflow engine supports multiple stores with specific business rules as well as business-to-business and business-to-consumer models. The workflow engine assists in creating and enforcing business rules and policies, as well as providing a routing mechanism for operational processes (e.g., content upload approval). Generally, the workflow engine supports either an intranet or an extranet workflow process.

Search Engine

The search engine is used to find specific items in the site catalog[s], to research the customer service knowledge base, and to search documents in the file system. The search engine provides fast searches of indexed data stored in the RDBMS using both simple, full-text and structured/parametric searches. The search engine should allow for incremental indexing of new content and for multiple search operators (Boolean searches).

Customer Loyalty Management

This component provides management tools to track the loyalty level of customers. It retrieves information from the web storefront and from the POS systems (e.g., loyalty card information) and provides this information to the user. It also maintains the user loyalty points and reward levels.

Data Conversions & Interfaces

This component highlights the methods of data conversion of the catalog, inventory or pricing data (ASCII format, XML possibly in the future) that is supplied through interfaces from partners or business systems.

Data Layer

This layer represents the object relational databases and any other persistent data stores that will be used by the Channel Hub application solution. The types of back-office databases including ERP, CRM, data warehousing, customer service and store-front are identified and their database access mechanisms indicated.

Back Office Operations & Customer Service

This layer represents the business operations and how are performed. Typical systems include Financials, Customer Relationship Management (CRM), Customer Service, data mining, etc. This layer consists of the components that are used by Channel Hub personnel for managing the back-office operations (orders, collections, etc.); front-office operations (sales and marketing, customer service, etc.); managing and developing partner relationships; and the design, creation and publishing of the site.

Hosting Provider

This layer represents the physical deployment of the solution. It illustrates where and how the components are physically located and which services are provided.

Internet Service Providers (ISP) provide the necessary network bandwidth into the Internet backbone as well as system administration services and help desk. They provide value-added services such as database administration (DBAs), web server management, traffic analysis. The servers located at the ISP will be protected by firewalls to ensure maximum system and data security. Access to the data center will be controlled and limited to authorized personnel only.

The following services are provided by the enterprise data center and/or ISP:

Network Bandwith: Provides a link to the Internet backbone for the Channel Hub systems. Optimum network bandwidth is determined by the specific agreement between Channel Hub and the hosting provider, the hosting provider's network infrastructure and its proximity to major internet exchange points.

Coallocation/hosting facilities: Coallocation/hosting facilities: Most providers ensure reliability and high-availability by not having a single point of failure in their networks and hardware, redundant uninterrupted power supplies, complete redundant backup systems, and alternate network connections to the internet backbone. Other physical features of the provider's data center such as HVAC temperature control systems, secure cages for hardware, and seismically-braced racks add to a reliable environment for the web application.

Server Security: In a preferred embodiment, security is provided at the physical level by a data center that is monitored by video cameras and other surveillance equipment with controlled access to authorized personnel as well as by supporting the network and application security features such as firewalls, proxies, and security protocols.

Systems management and monitoring: In a preferred embodiment, the ISP uses special software to monitor the performance of the system including network utilization, hardware usage, and key database parameters. This monitoring software lets the ISP gather statistics and report these statistics to Channel Hub to understand system usage and improve the overall service.

Data backup: This includes scheduling and execution of system, database and application backup as specified by Channel Hub. In a preferred embodiment, it includes tape storage and off-site tape storage services.

Application Module Requirements & Integration

This section provides a brief overview of the application modules, with their functionality that needs to be implemented to support the functionality and business requirements of the Channel Hub Network.

Integration Model

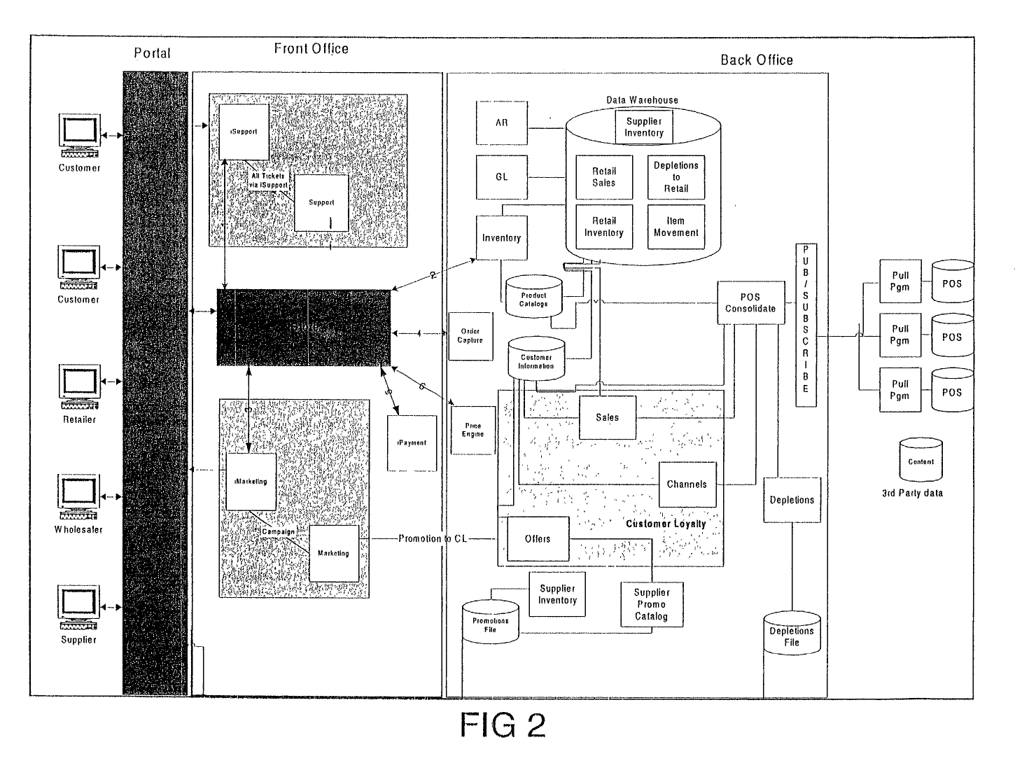

The application integration module is illustrated in FIG. 2. The individual components are described as follows:

Internet Store Application

This application provides standard functionality for users to shop online. In a preferred embodiment, Oracle iStore is used for this application. For purposes of describing the best mode for practicing the invention, reference is made herein to Oracle iStore, although it should be appreciated by those having ordinary skill in the art that other application modules could be used or developed. In a preferred embodiment, iStore provides the following functionality and integration points:

Functionality

1. A catalog creation and navigation system that allows simple content management, daily inventory loads and price list loads from the data warehouse, allows products to be categorized and displayed to different users, provides a pricing engine to calculate customer-specific pricing and special discounts

2. A customer account management system for registration of users (e.g., as a store customer, a retailer, a wholesaler or a supplier) and customer profiling (e.g., passwords, addresses, payment and shipment methods, e-mail addresses, wine preferences, etc.). The registration process would be customized to support the specific Channel Hub business flows.

3. An order checkout process for users to browse and place items into a shopping cart, to check out and place the order online together with shipment and payment details. The order placement process would be customized to support the specific Channel Hub business flows. Gifts and Wine Club memberships may be ordered by store customers within the iStore system.

4. A multiple storefront support for the setup of the various online stores for the different retailers under the Channel Hub network. The storefronts may also be customized to have up to three different look and feel.

Integration Points

iStore maintains integration points with other modules to provide the services that Channel Hub needs:

1. With Inventory to retrieve inventory information on each product;

2. With Operational Data Store to retrieve catalog, order and user information;

3. With Order Management to take online orders and pass to the retailers;

4. With Oracle Portal for single sign on information and other user profile information;

5. With iMarketing for promotions or campaigns information; and,

6. With iPayment for online payment fulfillment.

Oracle Intermedia

Functionality

1. Allows user to search for relevant information in the large Channel Hub repository (e.g., search for products in iStore, search on order histories on the Portal, wine reviews and ratings, etc.).

2. Allows users to sort or sub-query search results.

Oracle Portal

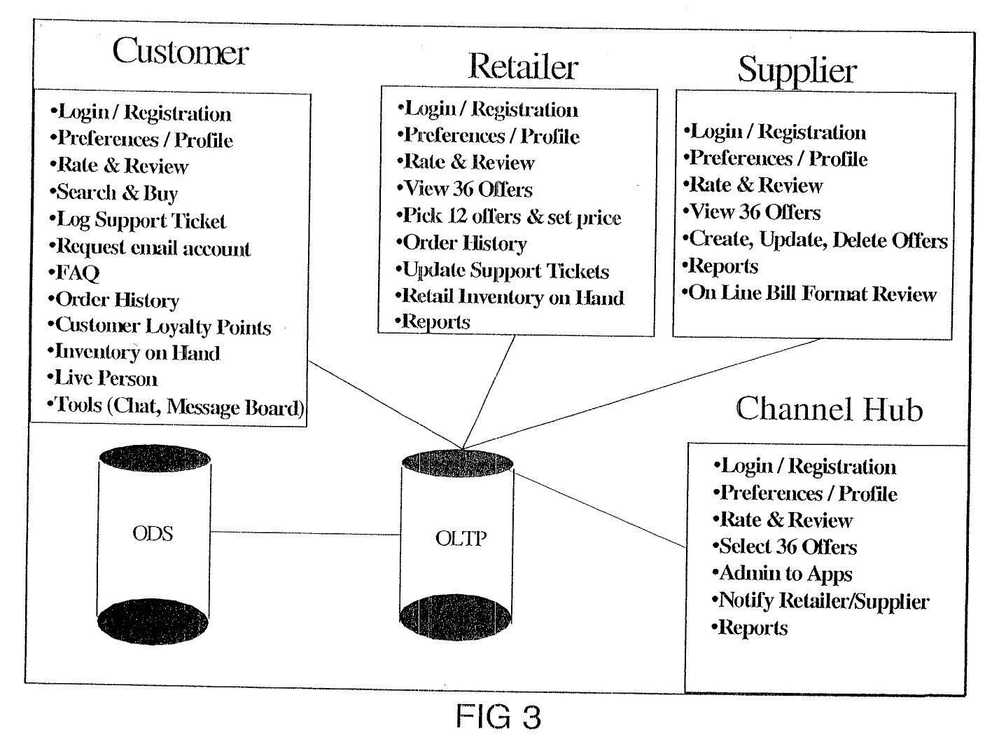

Oracle Portal allows the easy creation and maintenance of Channel Hub portals for different web users, (i.e., store customers, retailers, wholesalers and suppliers). The portal views for each of these members in the network are illustrated in FIG. 3.

General Functionality

1. A portal infrastructure for effective creation, deployment and management of “Enterprise Information Portal”.

2. An extensible framework for creating integrated view of community applications.

3. A tailored working environment that allows users to personalize their own portal experience.

4. A simple, straightforward means for users to publish and manage content, initiate workflow-enable business processes by using a workflow builder.

5. A single point of sign on (authentication) for users to allow login by email/password or loyalty card information.

Channel Hub Portal

This is the portal for Channel Hub employees that allow them to write reviews, run reports, setup unbranded items and administer promotions, billing setup and users.

Functionality

Login/Logout

1. This is a way for the user to logout to close the session or to re-login if the session expired for some reason like timing out.

2. The user has access to separate applications. Functionality is provided to permit a single username/password to access all these modules.

Rate and Review Wines

1. The user can fill out a web form that asks predefined questions to rate a wine product. The form also permits free-form text for a review of the wine product.

2. The average numerical rating and other reviews are displayed for the product being reviewed.

3. When entering a review, the user can see other reviews of the same product.

4. Professional reviews can be added by Channel Hub personnel.

Administer Other Oracle Components

1. Link to administer pages of the relevant Oracle application.

Run predefined reports

1. Allow Channel Hub to run all reports available through Discoverer.

2. Display results of reports on web pages.

Allow Promotion selection

Allow Channel Hub to select a set of promotions from the entire list of promotions. Those will be displayed to retailers who then select a subset that they will use. In a preferred embodiment, the set contains thirty six (36) promotions and the subset contains twelve (12) promotions.

Administrator User Preferences/Profile

1. Link to iStore's customer setup/preferences page.

Integration Points

1. With operational data store.

2. With Marketing Online to get and set promotion information.

3. With Discoverer to run and administer reports.

Retailer Portal

This is the home page for a retailer. There are two types of users for this page: those that can write reviews and ratings and those that can use the reporting and promotion parts of the portal.

Functionality

Login/Logout

1. This is a way for the user to logout to close the session or to re-login if the session expired for some reason like timing out.

2. The user will need access to separate applications. Functionality is provided to permit a single username/password to have access to all these modules.

Rate & Review Wines

1. The user can fill out a web form that asks predefined questions to rate the wine product. The user can also use free-form text to write a review of the wine.

2. The average numerical rating and other reviews are displayed for the product being reviewed.

3. When entering a review, the user can access other reviews of the same product.

Update a Support Ticket

1. List all the support tickets assigned to that retailer.

2. A web form is created to answer the ticket and submit it back to the customer that logged it.

Check/Update Inventory

1. Poll master catalog for product information for that retailer.

2. Enables retailer to update catalog entry and submit it to the Channel Hub for adding to the catalog.

Sign-up for Promotions

1. Enables retailer to select a subset (e.g., 12) of promotions from a set (e.g., 36) of promotions and set the prices for the products in that promotion.

2. Allow download, shelf and stack promotional material.

Show Unbranded/Under-branded Items

1. Display the list of items that a supplier wants to promote.

2. Provides an e-mail link for the retailer to contact the supplier through to negotiate the terms of the order.

Order History

1. List the orders assigned to the retailer in three categories: Club membership, orders picked up “closed”, orders yet to be picked up “open”.

User Preferences/Profile

1. Provides a link to iStore's customer setup/preferences page.

Integration Points

1. With Operational Data Store to retrieve items marked as unbranded/underbranded.

2. With Operational Data Store to store and retrieve wine reviews.

3. With Operational Data Store to retrieve completed order history for a retailer.

4. With iSupport to update support tickets.

5. With Marketing Online to get promotion information.

Supplier Portal

This is the home page for Channel Hub Network authorized suppliers. Suppliers can track product and promotions and add/update candidate promotions.

Functionality

Login/logout

1. This is a way for the user to logout to close the session or to re-login if the session expired for some reason like timing out.

2. The user has access to separate applications using a single username/password.

Rate/Review Wines

1. The user is presented with a list of the wines he has purchased and can pick one to write a review about.

2. The user can fill out a web form that asks predefined questions to rate the wine. He can also use free form text to write a review of the wine.

3. The web site displays the average numerical rating and other reviews for the product being reviewed.

4. When entering a review, the user can view other reviews of the same product. Customer here refers to a user that will order products from retailers and purchase the product at the retailers physical store. This is the portal that Channel Hub customers will see after they log in. This is the customer's home or ‘My’ page that will serve as the starting point to all the features a customer has access to.

Functionality

Login/Logout

1. This is a way for the user to logout to close the session or to re-login if the session expired for some reason like timing out.

2. The user will need access to separate applications. Oracle will build in the functionality to provide a single username/password to all these modules.

Rate & Review Wines

1. The user will be presented with a list of the wines he has bought and will pick one to write a review about.

2. The user will be allowed to fill out a web form that asks predefined questions to rate the wine. Also, it will allow for free form text to write a review of the wine. (review cannot be done without rating.)

3. The average numerical rating and other reviews will be displayed for the product being reviewed.

4. When entering a review, the user will be able to see other reviews of the same product.

Log a Support Ticket

1. The user can link to iStore and FAQ's

Search/Buy a Product

1. Link to iStore for searching and placing an order

Chat with a Technical Support Person

1. Link to LivePerson for online, chat/technical support.

News/Reviews

1. Display the headlines from a news feed that links to the article on Channel Hub site.

2. The Network publishes a newsfeed on the site through an article approval process.

Check Customer Loyalty Points

1. Report the number of loyalty points the user has for all her loyalty cards.

Open E-Mail Account

1. Link to a third party e-mail registration page.

Order History

1. List the orders a customer has made in three categories: Club membership, orders picked up “closed”, orders yet to be picked up “open”.

User Preferences/Profile

1. Link to iStore's customer setup/preferences page.

Integration Points

1. With Operational Data Store to retrieve the loyalty points per card per user.

2. With Operational Data Store to store and retrieve wine reviews.

3. With Operational Data Store to retrieve completed order history for a customer for customer review as well as determining what wines can be reviewed.

4. With “published” article providers for news feed.

Online Payments

This module enables clients of Channel Hub to make payments online. In a preferred embodiment, the present invention uses Oracle iPayment for this service.

Functionality

1. Integration with multiple payment processing systems for bank account transfers between Channel Hub and its clients (i.e., retailers, wholesalers and suppliers).

2. Rules based payment processing: allows merchants to determine what payment options based on predefined rules.

3. Industry standard security support such as SSL and SET to ensure payments are handled securely.

Integration Points

1. With iStore to handle bill payments.

2. With external payment clearing systems for settlements.

Electronic Data Interchange (EDI) Gateway

In a preferred embodiment, Oracle's EDI Gateway provides consistent standards-based solutions for integrating Oracle Applications with third-party applications, both inside and outside of the Channel Hub Network. The Oracle EDI Gateway creates an electronic transactional channel between the Channel Hub, the retailers, wholesalers, suppliers and other third parties.

Functionality

1. Enables Channel Hub to send bills to its clients electronically.

2. Enables Channel Hub to receive bill payments from its clients electronically.

3. Enables Channel Hub to receive bills from third-party.

5. Enables Channel Hub to pay its third-party solution providers electronically.

Integration Points

1. With Account Payable and Account Receivable for bill and payment information.

E-Mail Hosting

The e-mail hosting module enables customers to have an e-mail account under a corporation.

Functionality

1. Provide customers with an easy and secure access to e-mail online.

2. Provide customers “space” to store e-mail messages.

Integration Points

1. With Hosting Service to link the domain names.

Customer Loyalty

The present invention includes a Customer Loyalty component. This component is a business to consumer solution that enables Channel Hub to gain intelligence about who its most loyal customers are, develop a strategy to further influence their buying habits, and profile them to target current non-customers for the purpose of increasing market share and corporate profits.

Functionality

1. Enables Channel Hub to gain a 360-degree view of its customers.

2. Identifies the decision makers and who influences the buying within the household.

3. Profiles this information to target other consumers who resemble that consumer.

4. Maximizes its relationships with existing customers and then grows its business by enabling the corporation to implement targeted strategies to attract new customers.

5. Assists in gaining market share across multiple business lines. Customer Loyalty's 360-degree view elevates and focuses the marketing interactions with the consumer.

Components

CRM Panarama

The crux of the Customer Loyalty solution is the CRM Panarama. The CRM Panarama is the common customer data model that provides a consolidated view of customer information along with additional marketing information for these customers. In addition, prospect information (including marketing information) can be loaded into the CRM Panarama. Once loaded, marketing campaigns can be created and monitored by the Marketing Applications using the data from the CRM Panarama. In a preferred embodiment, both the customer consolidation and marketing enhancements use the commercially available Acxiom products.

Link to External Data Sources (Acxiom)

A link to the Acxiom databases are provided in the Customer Loyalty solution. The link operates in two ways:

1. Customer Updates

For initial customer data loads, the Acxiom Abilitec software provides the capability of cleansing, consolidating, and providing latest address information to the customer records. In addition, a unique identifier is applied to the customer record for unique customer tracking. In addition, data can be sent on a periodic basis for additional cleansing and consolidation. This allows for changes in customer information and increases the effectiveness of direct marketing campaigns. Additional marketing information provides a customer profiling and marketing capability to the system.

2. Prospect List Generation

In addition to customer data updates, prospect lists are available from Acxiom. These prospects (individuals who are not customers of Channel Hub) are downloadable into the CRM Panarama for additional analysis, modeling, and marketing campaigns. As part of the Customer Loyalty solution, an interface is provided for this function.

Data Warehouse & Application

Customer loyalty enables a consolidated view of customer, channel and sales. This integration makes it possible for Channel Hub to understand information from multiple “touch points” throughout the information system. In addition to this capability, reporting is provided that allows for the analysis of target segmentation, profiling and statistics. In a preferred embodiment, the following reports are provided, although other reports may be provided as appreciated by those having ordinary skill in the art:

1. Reports which provide information on “Who is my customer?”

2. Reports which provide information on “What is loyalty?”

3. Reports which provide information on “What is my coverage?”

4. Reports which provide information on “What is my performance?”

Customer Loyalty Points Monitoring and Storage

Members of the Channel Hub Network have a loyalty card which is used in both the retail store and the web. Based on the loyalty information, points are assigned by the retailer (known as retail points) and passed through the POS systems. A redemption module is used that enables redemption of the loyalty points.

Operational Data Store

The Operational Data Store (ODS) component provides an integrated platform for designing and building enterprise data warehouses, data marts, and e-business intelligence applications. The Channel Hub system feeds from the point of sale (POS) systems that are provided by the retailers in the field. The current product and inventory levels from the retailers are loaded in via the POS systems and loaded into the ODS. This mechanism allows for almost up to date inventory (either by “Plentiful”, “Out of Stock”, or quantity) to all actors (Retailers, Suppliers, Wholesalers, Customers) in the Channel Hub system. The information in the Inventory ODS is consolidated and cleansed so an integrated, time variant, subject area oriented view is provided. This view of information in the data warehouse is used for marketing, item movement, reporting, transactional, and the value chain for supply planning.

Marketing

In addition to the inventory ODS, marketing is integrated within inventory. Specifically, there is an integration between the customer loyalty data model and the inventory data model. This is mainly to report on inventory and price activities across products, promotions, time, retail store, and supplier.

Item Movement

In addition to understanding current inventory levels, the inventory ODS allows the Channel Hub, retailers, and suppliers the capability of understanding item movement within the retail stores. Essentially, if item location information is transferred via the POS system to Channel Hub, another dimension can be added to the inventory view; sales by item placement. For example, item sales can be tracked by where they are in the retail store (front display, isle, etc.). This aids in providing PlanOGrams to the retailer.

Reporting

For the inventory ODS, data for reports provides a flexible, user friendly format. Since the database is designed in this format, it facilitates easy end user access (providing the business areas are setup for the ad-hoc reporting tool). In a preferred embodiment, five reports are provided.

Order History

Order history is part of the inventory ODS. Assuming this information is provided in the POS feeds, it is loaded into the inventory ODS where it can be queried by retailers, customers, and Channel Hub. In addition, order information created from iStore is loaded into the inventory ODS for product reservations. Once the order is fulfilled at the retail store, the order status is changed to closed.

Value Chain for Supply Planning

One of the greatest benefits of the inventory ODS is that it provides a view of product flow across multiple areas of the supply chain (for example, from supplier to wholesaler to retailer). Specifically in the Channel Hub system, product flow can be measured by understanding what products sold today versus yesterday. This allows an understanding of current retail inventory less retail inventory from the previous day's load, excluding stock in the “back room”. This type of calculation helps both the retailer and supplier understand the Gross Margin Return on Inventory (GMROI).

Business Processes with the ODS

Retailer

Product Promotions

Once Channel Hub has chosen the thirty six (36) items to be promoted during the period, described in the Supplier and Channel Hub sections, the retailer chooses twelve (12) of these to be promoted during that period. Once chosen, the promotion information is extracted by Customer Loyalty and added to the data warehouse for analysis. Once the promotion becomes effective, the information is extracted from the POS systems and added to both the inventory ODS and Customer Loyalty data warehouse. This facilitates reporting and analysis.

Order History

As described in the Order Entry (iStore reservations) sections, the customer can enter orders (reservations) for products and also fulfill the orders at the retailer. From a retailer perspective, orders in multiple states can be displayed. The order history is stored in the inventory ODS.

Inventory Reporting

The retailer can report on inventory movement in the retail store and at higher levels (depending on single store, retail chain, etc.). Information from promotions, inventory, customer, product, time, and location are used for different views of the information for the retailer. This information is sourced from both the POS systems, Marketing, and iStore.

Value Chain for Supply Planning

One of the greatest benefits of the inventory ODS is to provide a view of product flow across multiple areas of the supply chain (for example, from supplier to wholesaler to retailer). Specifically in the Channel Hub system, product flow can be measured by understanding what products sold today versus yesterday. This allows an understanding of current retail inventory less retail inventory from the previous day's load, excluding stock in the “back room”. This type of calculation helps both the retailer and supplier understand the Gross Margin Return on Inventory (GMROI).

Sales Reporting

The retailer can report on sales in the retail store and at higher levels (depending on single store, retail chain, etc.). Information from promotions, inventory, customer, product, time, location will be used for different views of the information for the retailer. This is sourced from both the POS systems, Marketing, and iStore.

Supplier

Product Offer Management

The supplier can use the portal to view, create, and modify potential promotions for the retailer and supplier. Channel Hub can choose the appropriate promotions. Once chosen, the promotion information is extractable by Customer Loyalty and added to the data warehouse for analysis. Once the promotion becomes effective, the information is extracted from the POS systems and added to both the inventory ODS and Customer Loyalty data warehouse. This facilitates reporting and analysis.

Inventory Reports

The supplier can report on inventory movement in the retail store and at higher levels (depending on single store, retail chain, etc.). Information from promotions, inventory, customer, product, time, and location is used for different views of the information for the retailer. This information is sourced from the POS systems, Marketing, and iStore.

Value Chain for Supply Planning

One of the greatest benefits of the inventory ODS is to provide a view of product flow across multiple areas of the supply chain, (e.g., from supplier to wholesaler to retailer). Specifically in the Channel Hub system, product flow can be measured by understanding what products sold today versus yesterday. This allows an understanding of current retail inventory less retail inventory from the previous day's load, excluding stock in the “back room”. This type of calculation helps both the retailer and supplier understand the Gross Margin Return on Inventory (GMROI).

Sales Reporting

The supplier can report on sales in the retail store and at higher levels (depending on single store, retail chain, etc.). Information from promotions, inventory, customer, product, time, and location is used for different views of the information for the retailer. This information is sourced from the POS systems, Marketing, and iStore.

Wholesaler

Inventory Reports

The wholesaler can report on inventory movement in the retail store and at higher levels (depending on single store, retail chain, etc.). Information from promotions, inventory, customer, product, time, and location are used for different views of the information for the retailer. This information is sourced from the POS systems, Marketing, and iStore.

Order History

As described in the Order Entry (iStore reservations) sections, the customer can enter orders (reservations) for products and fulfill the orders at the retailer. From a customer perspective, orders in multiple states can be displayed. The order history will be stored in the inventory ODS.

Product Search

The customer can search for products in the Channel Hub system. These products are viewed by the retail store that is assigned to the customer. Via the web, iStore pulls item information from the retailer catalog (which is stored in the inventory ODS).

Customer Loyalty Points

Customers can receive loyalty points from the retailers. The POS systems provide loyalty information, including points (both accrual and redemption). This information is extracted to the inventory ODS and the Customer Loyalty data warehouse. Additionally, these points can be viewed on-line by the customer.

Channel Hub

This will facilitate the following business processes:

Product Offer Management

Channel Hub can use the portal to view and modify promotions for the supplier. Essentially, Channel Hub chooses a set of product families from the potential product family list created by the suppliers. In a preferred embodiment, Channel Hub chooses thirty-six (36) product families. Once chosen, the promotion information is extracted by Customer Loyalty and added to the data warehouse for analysis. Once the promotion becomes effective, the information is extracted from the POS systems and added to both the inventory ODS and Customer Loyalty data warehouse. This facilitates reporting and analysis.

Inventory Reports

Channel Hub can report on inventory movement in the retail store and at higher levels (depending on single store, retail chain, etc.). Information from promotions, inventory, customer, product, time, and location are used for different views of the information for the retailer. This information is sourced from the POS systems, Marketing, and iStore.

Sales Reporting

Channel Hub can report on sales in the retail store and at higher levels (depending on single store, retail chain, etc.). Information from promotions, inventory, customer, product, time, and location will be used for different views of the information for the retailer. This information is sourced from the POS systems, Marketing, and iStore.

Integration Points

1. Order entry process through iStore—Pull from iStore to ODS

2. Changes of customer information made on-line from the portal—pull from portal to ODS

3. Inventory changes made for product availability—pull from ODS to portal

4. Display of Order History—pull from ODS to portal

5. Reporting—pull from ODS via Discoverer

Site Analysis Tool (ClickStream)

Intelligent WebHouse Clickstream coalesces many of the vital website data components into a framework for leveraging customer relationships, behavior, and preferences, resulting in superior customer loyalty and an extended duration of the website visit. Intelligent WebHouse Clickstream provides analysis on several key measures including:

Customer demand

Promotional effectiveness

Affiliate relationship effectiveness

Demographic data collection

Customer buying patterns.

For Channel Hub, Intelligent Webhouse Clickstream is used for external website behavior activity and analysis.

For the external website, such as iStore for customers to place reservations on products or people just browsing, the Clickstream solution is used to gather valuable statistics (described above). With this information, Channel Hub can effectively manage the “stickiness” factor of customers through the web and be able to analyze the information collected. In a preferred embodiment, there are sixteen (16) pre-defined reports in Discoverer which enable Channel Hub to intelligently view this information.

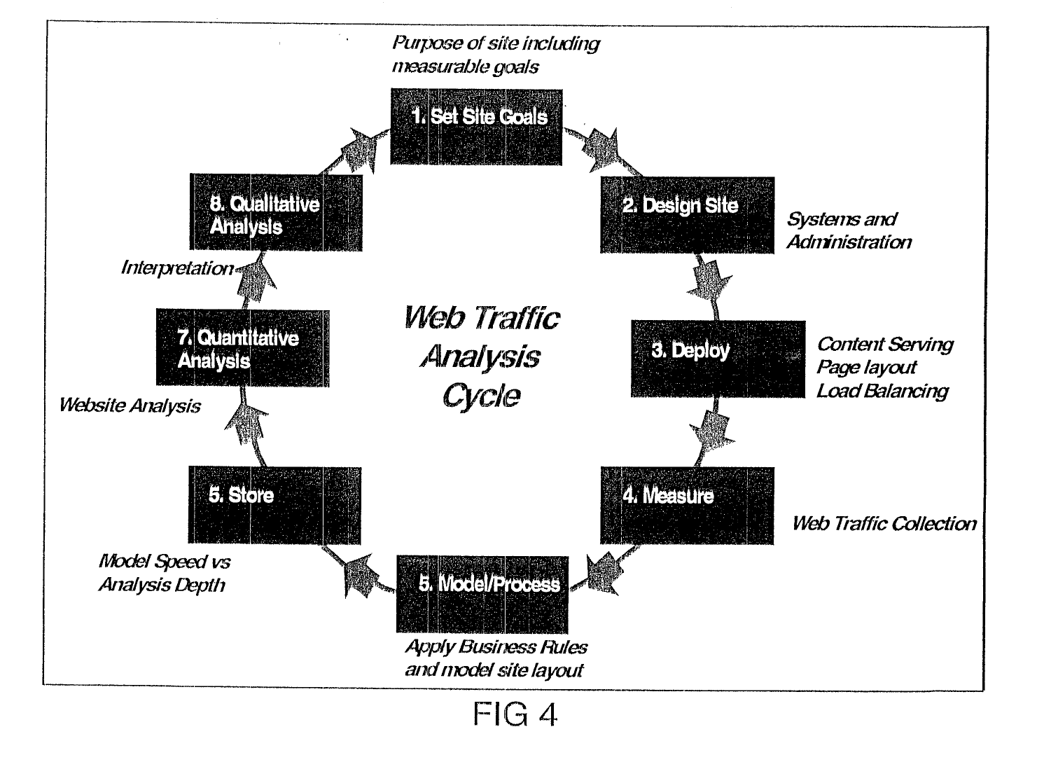

The Web Traffic Analysis Cycle is illustrated in FIG. 4.

Oracle Financial Analyzer

Channel Hub can forecast future sales and item movement based on specific promotions. For example, Channel Hub can test market a special promotion in a specific area. Based on the results of this promotion, Channel Hub can forecast retail sales and item movement in a similar area based on the same promotion. Once the promotion runs in the similar area, Channel Hub can monitor the effectiveness of the proposed promotion.

Integration Points

1. With Operational Data Store to obtain sales and marketing information.

Oracle Discoverer

Functionality

1. Provides an ad-hoc query tool to allow easy access to Channel Hub data like user preferences, orders, inventories, etc.

2. Provides sorting, totaling, summarizing and filtering tools.

3. Allows users to format reports with tables and cross-tabs.

Integration Points

1. With Operational Data Store to obtain user information, orders, inventories, promotions, etc.

General Ledger

The General Ledger (GL) system is a scalable, intuitive GL package, filly integrated with other financial applications for speed in closing financial books on a monthly basis.

Functionality

1. Allow for multi-company accounting for processing subsidiary companies accounting transactions.

2. Allow for intercompany accounting and eliminations.

3. Setup and maintenance of flexible chart of account(s) and sets of books.

4. Provide for trial balance, account analysis, balance sheet and income statement reporting.

5. Provide flexible report writing capabilities.

6. Allow for recurring, allocation and accrual journal entries.

7. Provide budgeting capabilities along with budget vs. actual reporting.

Integration Points

1. With Accounts Payable for invoice and payment accounting entries and drill down capabilities.

2. Accounts Receivable for sales and receivable accounting entries and drill down capability.

Accounts Receivable

The Accounts Receivable system is fully integrated with the General Ledger systems. The system also provides insight into Receivable aging, to facilitate follow-up efforts.

Functionality

1. Allow for input of invoices for the generation of invoices to your customer.

2. Allow for cash application against customer invoices.

3. Provide “Auto-lockbox” functionality, to automatically apply payments to customer accounts based on input tape from the bank.

4. Provide credit profiles for customers and reporting on credit limits.

5. Provide a collector workbench for tracking and collection follow up.

6. Provide full integration to the general ledger.

7. Reports of special note:

a. Customer Aged Trial Balance

b. Configurable Aging

Integration Points

With General Ledger for sales and receivable accounting entries and drill down capability.

Accounts Payable

The Accounts Payable (“AP”) system is fully-integrated with the GL system. The system has multiple-payment-term functionality, with the ability to set it up to automatically take discounts, based on supplier invoice terms.

Functionality

1. Allow for input of invoices for the generation of payment to your vendors.

2. Provide the ability to place vendors or invoices on hold.

3. On-line expense report entry capability, with the ability to automatically import employee expense reports for payment processing.

4. Generation of 1099 information capture and reporting.

5. Report of special note:

a. Configurable AP, aging

b. Discounts taken

c. Expense distribution

d. Positive pay report (for bank reconciliation)

e. Stopped Payments

f. Vendors & Invoices On Hold

Integration Points

With General Ledger for invoice and payment accounting entries and drill down capabilities.

Inventory

This module maintains information on both the items themselves (description, size, weight, source, and so on) and on the quantities of each item held by the company. It should be accessible by consumers from the ordering mechanism. It should also be accessible by suppliers, wholesalers and retailers (with security access) to permit maintenance of item information (description, size, etc.), and provide for upload of quantities on hand to facilitate consumer ordering.

Reports of Special Note

1. Item information listing.

2. Balance-on-hand listing.

3. Inventory valuation.

Order Management

Channel Hub needs to implement an Order Management (OM) system. This system should be capable of integrating with its web-based storefront Channel Hub. The system should allow its users to enter and change orders, view promotions, target promotions.

The abilities of the OM Module are summarized below. For Phase I, Channel Hub might not require all the OM abilities, but needs these for future system enhancements and capabilities.

Functionality

1. Able to capture orders from the Channel Hub store and to integrate order fulfillment status from the Data Warehouse system.

2. Workflow-based, so as to enable automatic notification of order information to customers, send orders to retailer systems, route different types of orders base on predefined criteria, allow order statuses to be updated.

Reporting

The Order Management System should also include reporting capabilities. Some of the typical OM reports are identified below:

1. Order Detail

2. Order Discount Detail

3. Orders on Hold

4. Canceled Orders

5. Channel Hub Salesperson Orders

6. Order Invoice Summary

7. Orders by specific customers

8. Orders by Item

Integration Points

1. With iStore to provide capture order information.

2. With Operational Data Store to update web order statuses.

Marketing/iMarketing/Marketing Encyclopedia System (MES)

The marketing systems enables Channel Hub and the suppliers to create real-time, targeted promotions and product recommendations on the e-commerce site, set and approve promotion budgets, and manage the cost of promotions. It facilitates measurement of results to help determine the most-effective/profitable marketing activities. It also allows the user to charge for events, manage affiliate links, and report on marketing activity. In a preferred embodiment, the marketing system is integrated with the procurement web site, and facilitate real-time analysis of results to enable quick reallocation of resources to successful campaigns.

Also in a preferred embodiment, the system has the ability to profile customers based on selected criteria such as sales cycle, payment preference, and purchase frequency, to tailor messages and campaigns with better accuracy for highly focused, individualized marketing campaigns. The ultimate objective of this system is to facilitate the development and management of programs to increase revenues, build customer loyalty, and extend a company's brand presence, while minimizing cost to the company.

Artwork management of promotional pieces enables receiving and categorization of pictures form supplier for placement on appropriate advertising campaign.

Functionality

1. Manage multiple overlapping campaigns management.

2. Collateral management- including flexible definition of electronic files for later physical or electronic fulfillment.

3. Campaign planning & budgeting.

4. Flexible rule-driven campaign selection and display

5. Out-of-the-box integration with other applications, including the procurement web site.

6. Personalization through customer segmentation.

7. Response management.

8. Summary and detail calendar views of promotional activity to coordinate execution of campaigns.

9. Event management with tools to create and monitor promotional events with associated dates, activities and budgets.

Customizations for Channel Hub

1. Web portal access for retailer to pick campaign choices, finalize items and enter prices.

2. Email (std) additional data: inventory, margin, etc. (non-marketing data).

3. Detail format for billing emails, advertised items, and artwork.

4. Weekly ad web page.

5. Capture and display surveys and reviews and ratings.

6. Matching preferences based on flavor, type, inventory levels.

Integration Points

1. With email Center.

2. With iStore.

3. With Order Capture.

4. With Support.

Support/iSupport/email Center

The system has a comprehensive, Web-based customer care system that enables Channel Hub to proactively provide customer service and support in a self-service environment, while simultaneously reducing cost.

Customers are able to view current and past transactions such as order history, invoices, and payments. Customers may also want to participate in on-line interactive forums to ‘discuss’ hot topics. Redirecting common service requests to the Web and offering automated response mechanisms also allows retailers to realize significant savings on customer support/call center activity.

Functionality

1. On-line request management.

2. Inquiries on-line including tracking number.

3. Knowledge base searches for on-line answers to questions, categorized as determined by Channel Hub.

4. Personalized home page.

5. E-mail access.

6. Initiate and manage outbound interactions.

7. Forums.

8. Allows coverage of product information, problem posting for solution access, capture of customer, address, and contact history for all request, task assignments.

Customizations for Channel Hub

1. Third party product for chat window.

2. Matching based on inventory levels.

3. Portal views to iSupport for end user and retailer.

Integration Points

1. With Support

2. With MES

3. With eMail Center

4. With Order Capture

5. With Contracts

Customer Care

This system is designed to equip Channel Hub customer care agents with the required tools to enable them to efficiently and accurately resolve problems presented by the customer. It provides a seamless and consistent front end to various functions carried out by the customer care agent.

Functionality

Through a user customizable Dashboard and Contact Center, Customer Care provides the Channel Hub customer agent with a comprehensive view of the customer including:

1. Full access to interaction history.

2. View of open service requests and sales orders.

3. Static customer information.

Contract Core

Channel Hub can capture and maintain contracts for each customer including all terms and conditions of these contracts. The system allows for soft copy storage for audit and hard copy printing for customer signatures.

Functionality

1. Authoring, execution and control of both buy and sell contracts.

2. Helps to manage internal and external obligations.

3. Ensures ability to capture contracts and enforce business processes and legal obligations.

4. Enforces quality standards, versioning, mass renewals.

5. Full life of contract is stored on-line and accessible at a single source for review on-line or print.

Integration Points

1. With Order Capture

2. With Support

3. With Install Base

Live Customer Service (Live Person)

Functionality

1. Provide customers with instant online communications to answer questions, solve problems and close sales (e-tailing).

2. Provide 24 hour/7 day/week customer assistance with same level of personalized service as traditional methods.

3. A direct e-mail tool from customer to customer service.

4. Provide custom and pre-formatted responses to customers.

5. Customers have the option to chat, search the FAQ knowledge base or e-mail you.

6. During off hours customers can get their questions answered through FAQ pages or they can choose to e-mail you.

7. Provide increased operator productivity (each can conduct up to 4 simultaneous conversations).

8. Provides mechanism to obtain immediate and real time feedback on site features, merchandise, pricing and customer needs.

9. Convert online opportunity to a successful result purchase of completion of transaction.

Standard Reports

1. Back-end features: such as a customizable end of call survey.

2. A customer profile filtering system.

Integration Points

1. Open message platform to exchange information from browser to browser across Internet real time.

2. Text, HTML and XML connections are routed and managed by application servers.

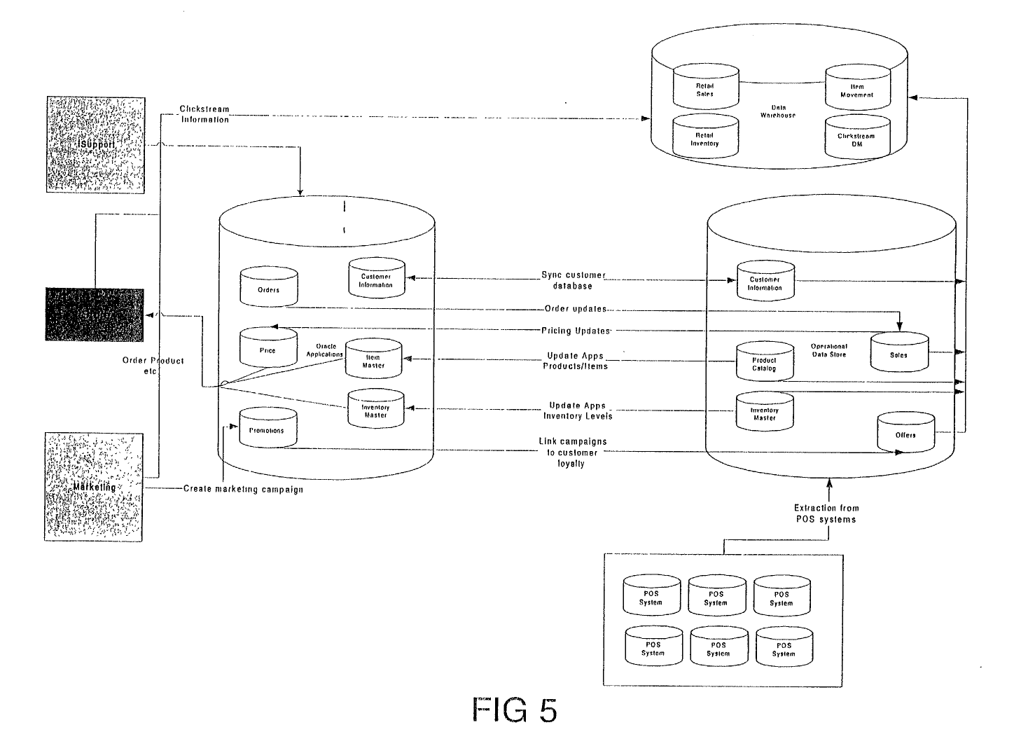

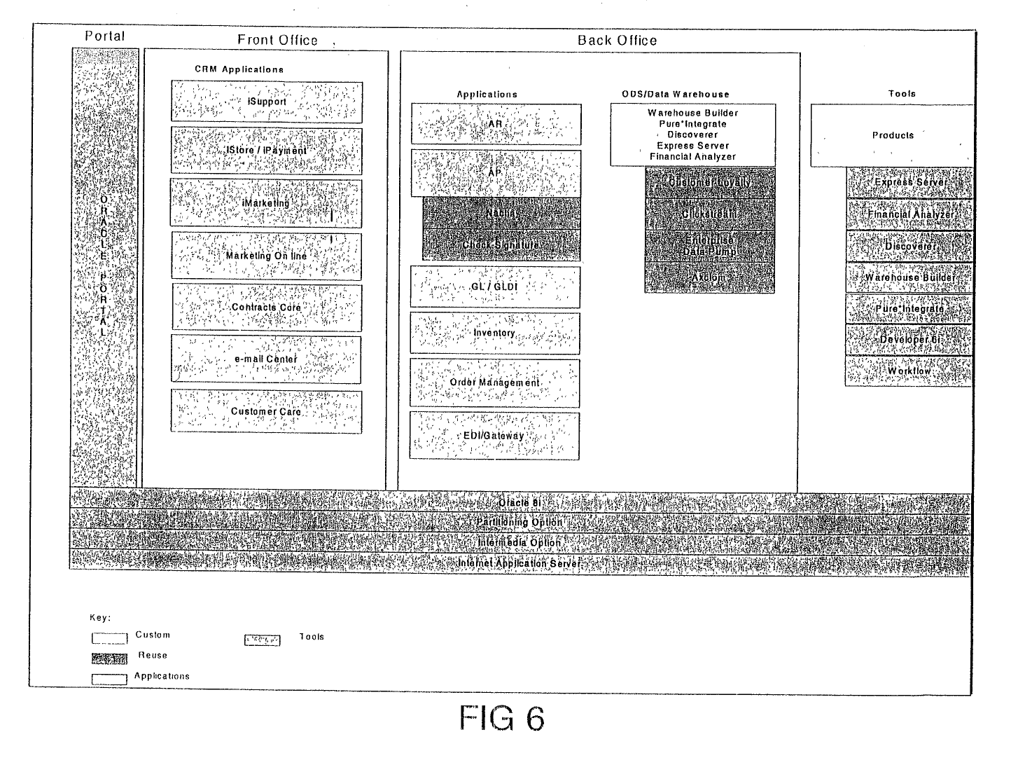

FIG. 5 illustrates the data flow between applications as described above, and FIG. 6 illustrates the product mapping.

Technical Architecture

Capacity Planning Requirements

Objectives and Definition

It should be appreciated by those having ordinary skill in the art that the technical architecture necessary to implement the present invention can be achieved in a number of different forms, sizes and shapes. The present invention contemplates scalability, and scale dictates technical architecture. Therefore, the description of the technical architecture provided herein contemplates and assume a static size and capability of the architecture, with the understanding that the architecture may change with size and capability. The description of the technical architecture is based upon an estimate of the capacity of the hardware and network infrastructure required to run Channel Hub's Marketplace while meeting the designed volume, performance and availability objectives.

A capacity plan, in general, consists of calculation of processing (CPU), memory, disk space, network and infrastructure requirements for a piece of computer hardware based upon expected utilization characteristics of the given system.

Recommended Hardware Platform

This section documents a high level estimate for the hardware required to run the Channel Hub. The hardware requirements necessary to make and use the present invention can vary depending on a number of factors, including but not limited to: the number of transactions (business transactions, documents served), page hits and size of the participant databases.

Application Tier Servers

Depending upon the footprint and computing resource requirement of the Application Server, the HTTP Web Servers can either be run on the same box along with the Application Server or, separate farm of web servers can be deployed.

The application tier is typically memory and CPU intensive and requires machines with fast processors and lots of memory. In addition, fault-tolerance may be achieved by using multiple redundant servers and optimally running a hardware cluster. It is advantageous to use more than one server for redundancy to avoid the site being inaccessible due to a downed HTTP Web Listener.

As per the Volume Metrics, total number of business transactions to be handled per hour by the application tier is initially sized for the defined Web Order user and Browser uses. This can be handled by a (4CPUs and 4(6 months phase) GB memory), a Sun E4500 Sun Enterprise server is an example of this class of server.

In addition, since it is architecturally easier to add a member to a “web farm” (therefore obviating any need for a long term plan), it is proposed to start with 2×E4500 (2 for redundancy) only.

The systems should ideally be deployed in a fault-tolerant and intelligent load-balancing configuration.

In a preferred embodiment, the system will have the following configuration:

1. 2×(Sun Enterprise 4500 model (4×400 MHz UltraSPARC with 8 MB cache)

2. Total Estimated throughput 6166Transactions per hour—year 2

| | |
|---|---|
| Server | 2 |
| CPU (each) | 10 |
| Memory (each) | 10 GB |
| Disk Storage (each) | 72 GB |
| Concurrent users per day | 32889 |

Database Tier Servers

These servers run the CRM, Financials and the Oracle databases storing Channel Hub content and related transactional data (e.g., catalog, customer details, transaction history, inventory).

These application are typically I/O intensive and require lots of memory based on how many applications and stores will share the same server.

In addition, depending upon high availability needs, various options are available for disk storage sub-system. It would be recommended to use Fiber Channel Arbitrated Loop (FCAL) disk storage with redundant power supply, controllers and multiple I/O channels. For example, Sun StorEdge A1000 system gives the flexibility of configuration from 4-drive table top to a 108-drive rack-mount.

As per the Volume Metrics, total number of business events (transactions to be handled per hour) by the database tier is based upon the transaction volumes of the physical stores. This workload is handled by a class of machine such as the E6500 Sun Enterprise server with enough horizontal growth within the physical server to upgrade.

In a preferred embodiment, the Channel Hub system has the following configuration:

1. 1×(for example, Sun Enterprise E6500 model 9×400 MHz Ultra SPARC II with 9 MB cache)

2. Availability for this is described in greater detail in the “High-Availability Strategies” section.

| | |
|---|---|
| Server | 1 |
| CPU (each) | 20 |
| Memory (each) | 20 GB |
| Disk Storage (each) | 400 GB |
| Concurrent users per day | 32889 |

Email Server

This server will be used to integrate the Email components for the Channel Hub solution.

The proposed system will have the following configuration:

1. 1×(Sun Enterprise 450 model (4×400 MHz UltraSPARC with 8 MB cache)

| | |
|---|---|
| Server | 1 |
| CPU (each) | 4 |
| Memory (each) | 4.0 GB |
| Disk Storage (each) | 100 GB |
| emails | 1800000 |

Staging Server

This server is used to integrate the POS components for the Channel Hub solution.

In a preferred embodiment, the system has the following configuration:

1. 1×(Sun Enterprise 450 model (4 ×400 MHz UltraSPARC with 8 MB cache)

| | |
|---|---|
| Server | 1 |
| CPU (each) | 4 |
| Memory (each) | 4.0 GB |
| Disk Storage (each) | 200 GB |

Portal LDAP Server

This server is used to integrate the Portal Sign Sign On components for the Channel Hub solution.

In a preferred embodiment, the system has the following configuration:

1. 1×(Sun Enterprise 450 model (4×400 MHz UltraSPARC with 8 MB cache)

| | |
|---|---|
| Server | 1 |
| CPU (each) | 4 |
| Memory (each) | 4.0 GB |
| Disk Storage (each) | 200 GB |

Development & QA/Staging Requirements & Setup

The best practice is to have a separate Development and QA environment.

Requirements

In a preferred embodiment, the system has the following configuration:

1. 2×(For example, Sun Enterprise 450 model or equivalent server (4×400 MHz UltraSPARC with 8 MB cache, 4 GB memory).

2. Concurrent users—10

3. Instances—5 Demo, CRP, PATCH, TEST, DEV)

4. Apps Server—4 CPUs, 4 GB Memory, Storage 72 GB, equivalent to SUN E450

5. DB Server—4 CPUs, 4 GB Memory, Storage 110-160 GB, equivalent to SUN E450.

6. Warehouse Development Server—4 CPUs, 4 GB Memory, Storage 110-160 GB, equivalent to SUN E450

7. Staging Server—4 CPUs, 4 GB Memory, Storage 50-200GB, equivalent to SUN E450.

Setup

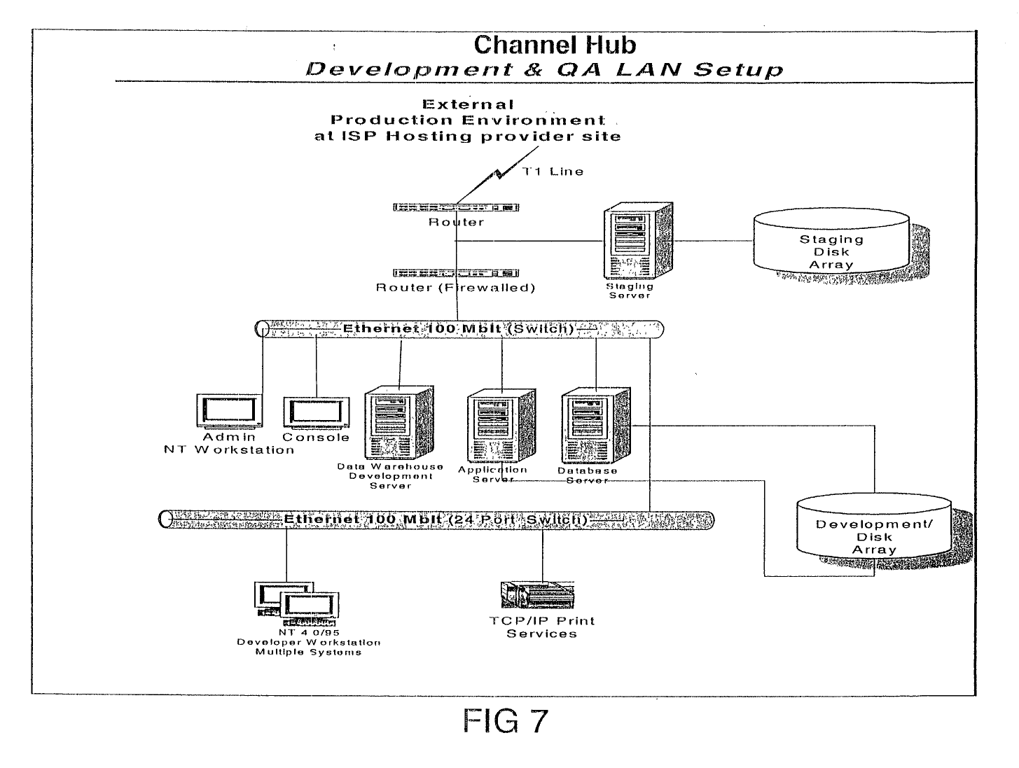

FIG. 7 illustrates the Development and QA LAN that exists at Channel Hub's Data Center to develop the Marketplace solution. In a preferred embodiment, this solution is located at the hosting facilities.

Channel Hub Hardware Configurations

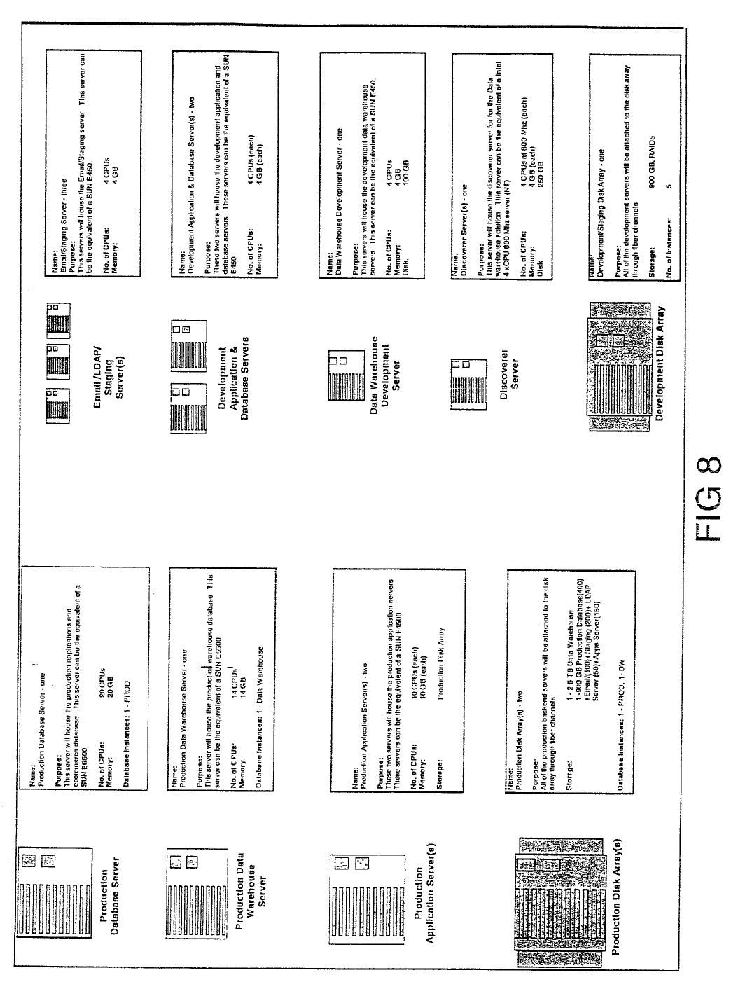

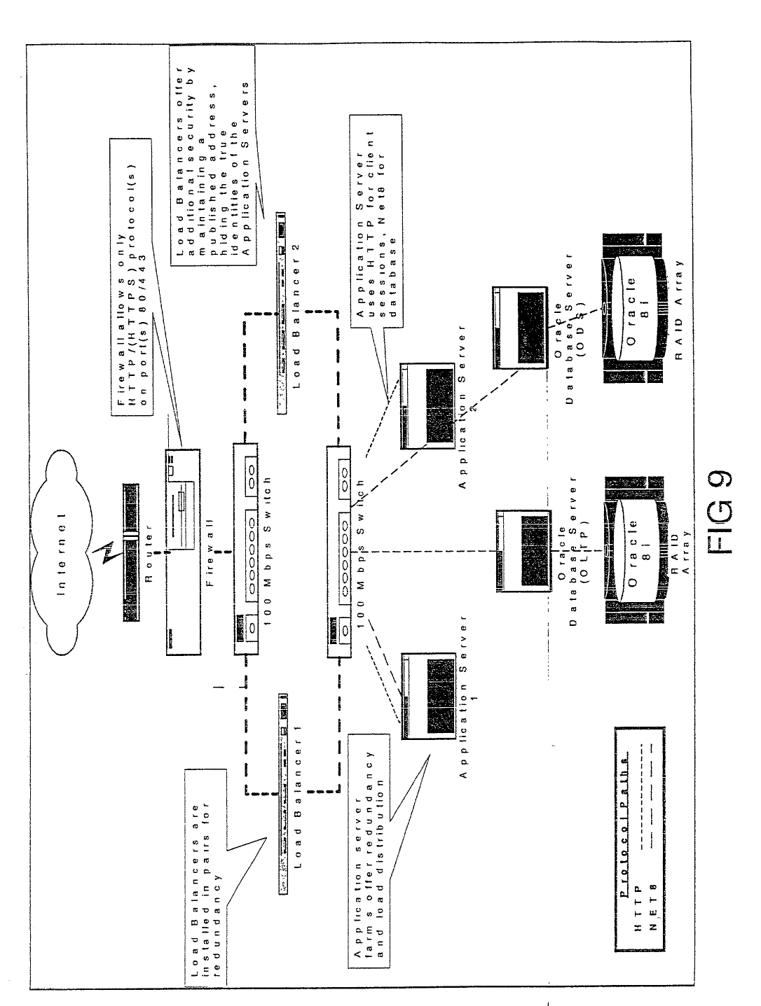

The preferred embodiment hardware configuration is shown in FIG. 8, and a representative architecture of the preferred embodiment is shown in FIG. 9.

Network Requirements & Recommendations

Network Segments

The Channel Hub Network includes the following segments:

Internet Backbone

The core of the Internet.

Internet Backbone Uplink

The method by which the Internet Service Provider connects to the Internet.

Head End Network

The local area network segment that connects the Web and Application Servers to the IPS's uplink. This network segment includes various components including security devices, load balancing devices, etc.

Web and Application Server Network

The network segment that interconnects all the web and application servers.

Mid to Data Tier Network

The network segment that connects the web and application servers to the back end system having the database.

External Network Uplink

The method by which the Hosting Provider connects to various external networks on behalf of Channel Hub including suppliers, vendors, financial systems, etc. In a preferred embodiment, this can consist of various dedicated networks including Virtual Private Networks, Extranets, dedicated leased lines, etc.

Mail Architecture

Mail Architecture

In the present invention, Channel Hub uses email as a keystone function to produce the following:

1. Email promotions via campaigns to customers (retailers, retail customers, wholesalers, suppliers)

2. Email as a sub-component on the e-commerce component of Channel Hub site

3. Email as a customer service process to its clients (retailers, retail customers, wholesalers, suppliers)

4. An email store (customer@Channel Hub.com) for customers who do not have an email account.

Mail Architecture for Channel Hub—Client Mail Store

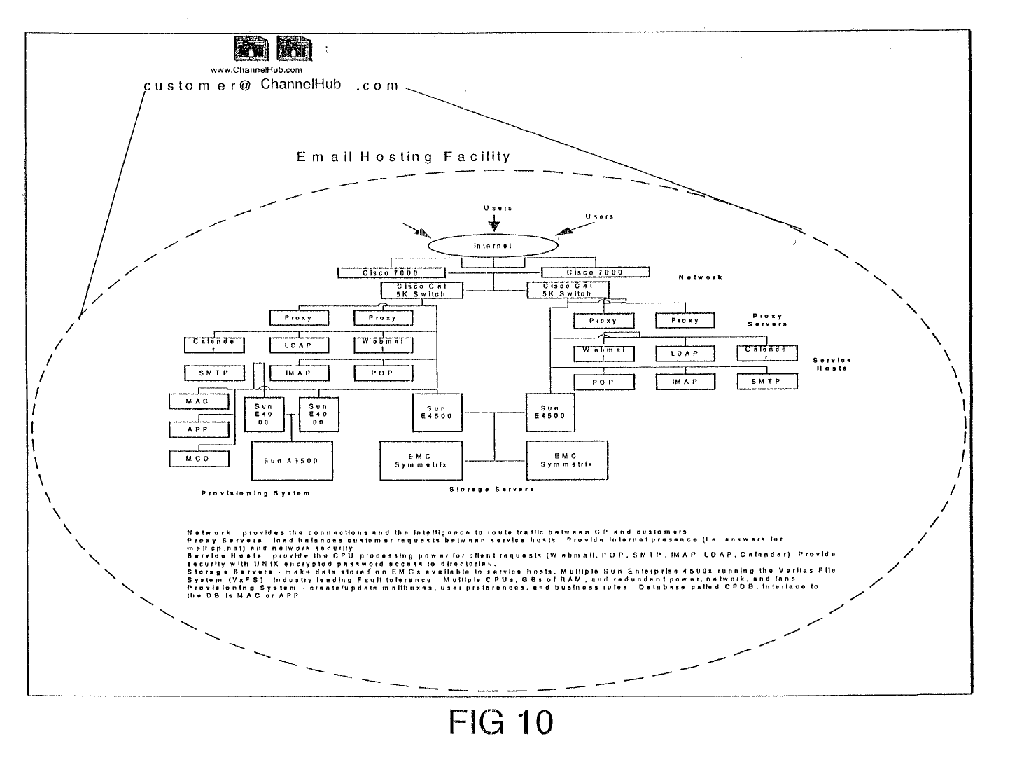

The Channel Hub Mail Store is illustrated in FIG. 10.

Mail Architecture for Channel Hub—Outbound

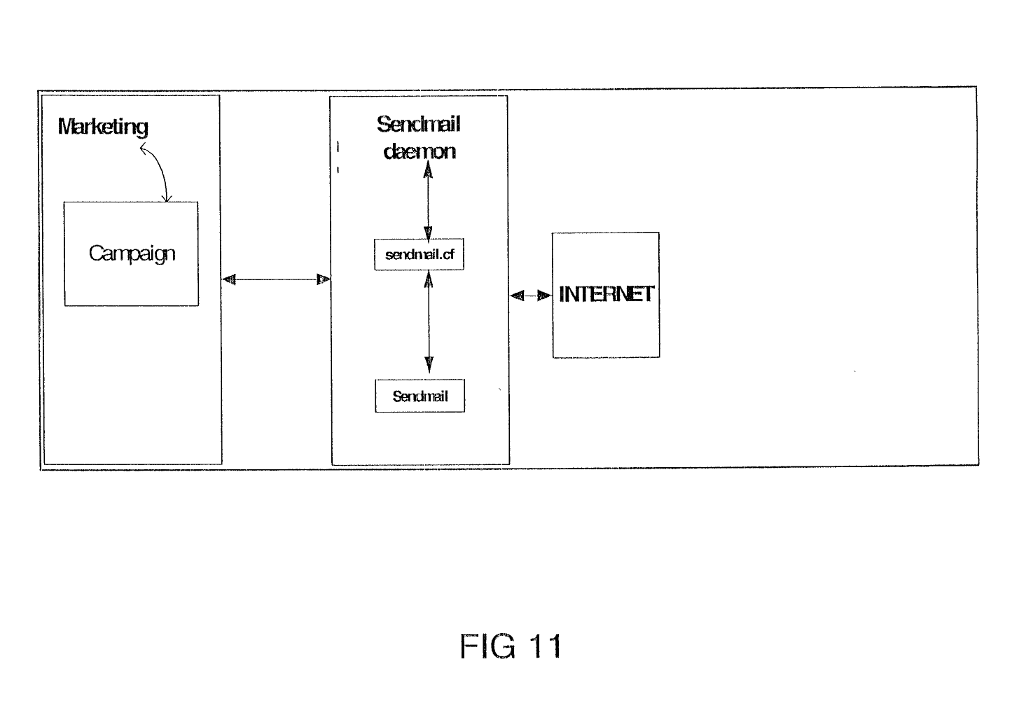

The components that make up the campaign solution to produce the outbound campaigns/emails to clients (retailer, retail client, wholesaler, and supplier) is illustrated in FIG. 11. The diagram illustrates that the campaign architecture uses and the SMTP native to the operation system to send out campaigns to the INTERNET.

Detailed System Architecture Footprint

The invention includes a co-location facility that provides a data center for hosting the hardware, software and networking components of the system as well as system administration services.

Channel Hub Deployment Topology

The Channel Hub Deployment Topology includes the following components, described as follows:

Architecture Components

Client Tier

1. Clients and Customers: The client workstations and software used by participants, Channel Hub and its partners to access the system components. It includes standard web browsers (e.g. Netscape Communicator and Microsoft Internet Explorer), Java Applets and Microsoft Windows (Windows 95/98 and Windows NT) clients. Customers use their standard web browsers to carry out their transaction over HTTP/HTTPS.

Customers use web browsers with standard HTML and maybe JavaScript. Channel Hub staff uses a mix of standard web browsers, Java Applications, Java Applets and Microsoft Windows-based clients.

The solution is flexible to support all of the aforementioned client types; however, the preferred approach is to use thin-clients as much as possible. Thin-client refers to end-users using web-based software to minimized the complexity, training and management requirements, cost and the number of software components installed at the client workstations.

2. Network (Internet, WAN, VAN): Channel Hub clients access the system using the Internet. Channel Hub's internal users access the system via their network fabric.

Application Tier

1. Firewall: A firewall consists of hardware, software or both and isolates the Channel Hub backend systems from the Internet. A firewall may include packet-level filtering and application relay (e.g., Proxy Server). The architecture is designed to place as much of data behind the firewall as possible for security.

2. Intelligent Load Balancing Device: Provides scalability and failover by directing HTTP page requests between the web servers (e.g., Cisco Local Director, ArrowPoint).

3. Web Servers: The web servers host the HTTP listeners. They can be physically co-located with the Application Servers (see below). Multiple web servers may be required as the web site traffic increases.

4. Application Servers: These servers host the intelligent application servers and are the middle tier in the Channel Hub Architecture. This tier provides access to the back-end database tier.

Database Tier

1. Database Server: This server hosts the database for all transaction data to serve Channel Hub Solution. This server infrastructure can be shared through multiple interfaces. This server hosts the Oracle 8i database[s].

2. In a preferred embodiment, the server is behind a firewall. Access to the Oracle database is possible via Net8 Tunneling which allows SQL*Net traffic to occur between the application servers and the Oracle database, using Oracle Java JDBC drivers or native OCI drivers. It is necessary to use a SQL*Net compliant firewall for NETS traffic.

Recommended Application Architecture

The front-office application architecture consists of Oracle's R11i eBusiness suites. The major component includes iStore and Oracle Portal (WebDB).

In addition to the front-office application architecture, most of the product information is loaded into and stored in an operational data store built using the Warehouse Builder Architecture. This information can then be loaded onto the storefront databases on demand.

iStore Architecture

Oracle iStore is an electronic commerce application which enables companies to build, manage, and personalize powerful and scaleable Internet storefronts. iStore may be used in both business-to-business and business-to-customer settings. With seamless integration to Oracle E-Business Suite applications, iStore provides complete web-based order taking integrated with order management and inventory management applications. It enables merchants to take advantage of sales, marketing, and service opportunities across customer communications channels.

Oracle iStore includes native integration to Oracle iMarketing which helps in attracting customers to the site and then effectively merchandising products to them so that more visits are converted into sales.

Built on top of Java Server Pages (JSP) and Oracle 8i, iStore provides an extensible and customizable solution for deploying web-based stores. iStore uses Java Server Pages to display content to end users. Merchants may use any HTML editing tool, or JDeveloper 3.0 to customize the look and feel of their sites as well as to take a building block approach of composing a page by using iStore's business objects. Additionally, merchants are able to supplement iStore's standard business objects with their own, thus provide an integrated front-end to their own extensions. iStore exposes its business objects and APIs in a way that merchants will be able to write their own, in addition to calling iStore's business objects and APIs.

Technology Components

1. Business Objects—The schema for representing and storing customers, orders, product catalog and presentation elements. These entities are persistent, shared across all Oracle applications, and manipulated by Java APIs provided within Oracle iStore 11i's runtime services.

2. Customer Facing UI—Referred to as templates in Oracle iStore 11i, essentially the UI consists of Java Server Pages (JSP). The application receives an HTTP request, executing the JSP. Accordingly, the JSPs use Oracle iStore 11i's runtime services to reply in HTML.

3. Runtime Services and APIs - The coupling of certain common services available within all e-commerce applications (Oracle Foundation) and Java based APIs (includes some PL/SQL APIs). This combination queries Oracle iStore 11i's persistent storage of objects and relationships and enables update operations.

4. Store Manager—The component that enables business users to manage the Oracle iStore 11i through the set up of data without programming knowledge.

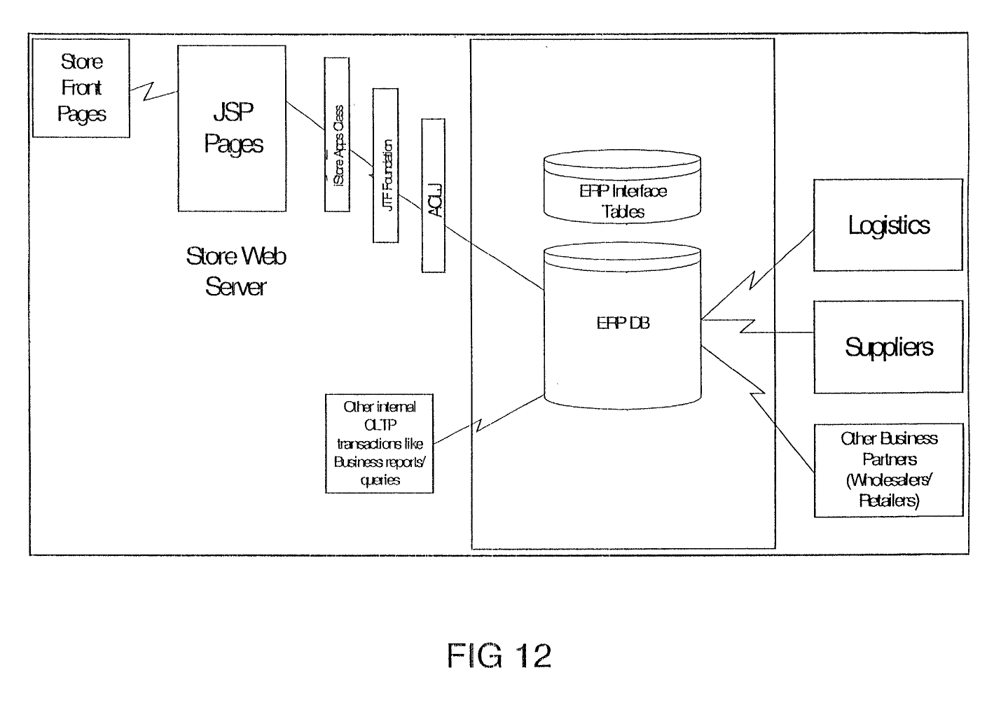

FIG. 12 illustrates the components, the architecture and the integration points with R11i components.

Oracle Portal (WebDB) Architecture

Oracle Portal (WebDB) is an electronic commerce application that provides a framework with which to organize, integrate, personalize and present data, content and application services for the extended enterprise. It provides a common, integrated starting point for personalized access to relevant enterprise information sources: enterprise applications, business intelligence, publishing and collaborative environments, knowledge asset repositories and other on-line resources.

Architectural Features

1. Extended Portal Framework—provides universal, standardized, secure access to nearly any Web-enable information resource contained within the corporate intranet, on the Internet, or from an extranet.

2. Personalized, integrated working environment—allows the portal to be configured and personalized for a variety of user communities such as employees, partners and suppliers.

3. Centralized portal administration—gives administrators the tools to easily and effectively manage portal deployment and administration.

Portlets

1. Oracle Portal uses re-usable information components called “portlets” to access Web accessible information—from Internet news and stock quotes, files published on the corporate intranet to reports on data managed by corporate applications. A portlet is a live area of HTML or XML which represents an information resource in a standardized, consistent and secure manner. Portlets summarize, promote or provide basic access to an information resource for a group of users who find business value in the information. Access is not limited to “public” information and can include secure, password-protected resources through integrated portal authentication and single-sign on. Custom portlets can be created by any application or information resource “provider”, based on published API specifications. Developers can create procedures as PL/SQL packages or Java classes.

2. Oracle Portal manages the portal user experience through the creation and administration of portal pages. Pages can take on a variety of forms; each is dynamically assembled and formatted according to the portlets and layout defined for that page.

3. Portal administrators use the page creation mechanism to create and publish default “global” pages, page templates (that individual users can further customize) or line of business specific pages. In this manner, portlets that access applications or content resources that are particularly meaningful to particular sets of users can be assembled, published within a portal page, and made available immediately.

4. Using simple dialog boxes and wizards, Portal users can personalize global pages created for them or create new pages which contain portlets of their choosing. A simple wizard defines the layout/style of the page, the portlets to be placed on the page and page access privileges. Portal page options allow a user to specify a wide range of page geometry, text and color settings, and access rights to the portal page.

5. Upon a user requests to display a page, a page engine dynamically assembles, formats and delivers the required HTML output according to the portlets and layout defined for that page.

6. Portal APIs support a wide range of implementation options: from a simple wrapper that calls out to existing functionality to a complex implementation of all UI and logic within the portlet procedures. In addition, providers can take advantage of a set of standard services for functions such as user preference management, session management, activity logging, translation, security and error handling.

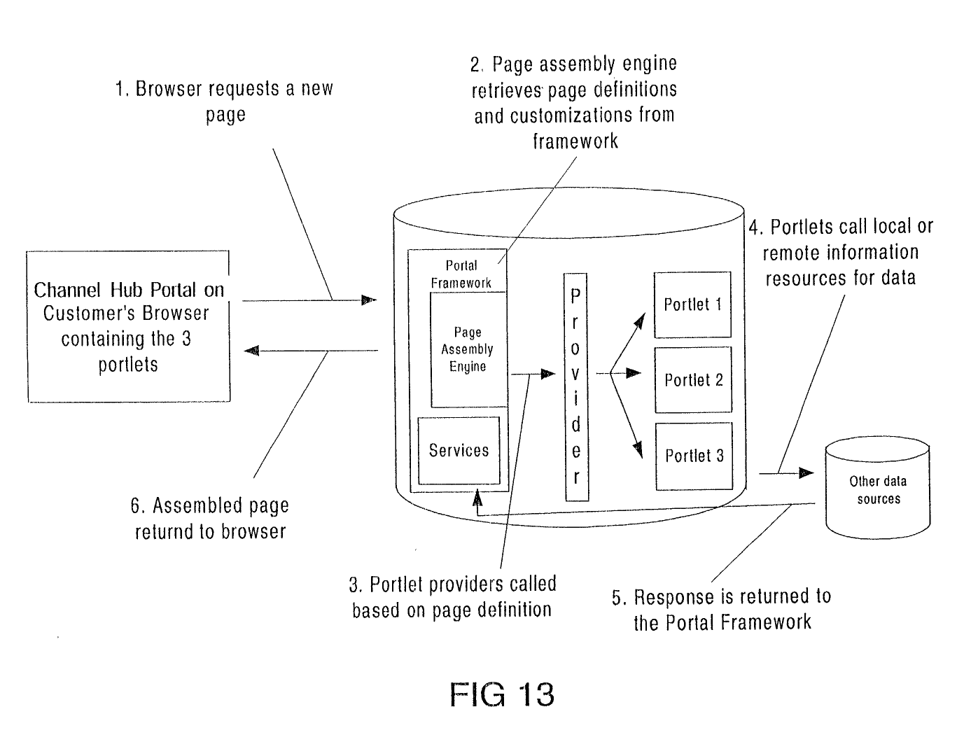

The Oracle Portal Architecture is illustrated in FIG. 13.

Warehouse Builder Architecture

The Warehouse Builder is used to build the operational data store. It can access a wide variety of data sources, including Oracle and non-Oracle databases, flat files, and Enterprise Resource Planning (ERP) applications. For the target design, it offers wizards and graphical editors that let the user create multidimensional (star) schemas. Sources and targets are also mapped together graphically.

Warehouse Builder generates code to implement the data warehouse. The multidimensional model results in SQL Data Definition Language (DDL) commands that, when executed in an Oracle8i database, create the target schema. For source-to-target mappings the generated code depends on the type of data source. For example, if the source is a database, Warehouse Builder generates a PL/SQL program that moves data from the source into the target. If the source is a flat file, Warehouse Builder generates a control file for SQL*Loader. The generated code is executed from a convenient deployment environment.

Warehouse Builder integrates with Oracle Enterprise Manager or third-party scheduling tools for ongoing maintenance tasks, such as incremental updates of the warehouse.

The metadata produced in the course of designing, building and maintaining the warehouse is stored in a repository for use by other tools.

Warehouse Builder consists of the following primary functional components.

Repository

The Warehouse Builder repository consists of a set of tables in an Oracle8i database that is accessed via a Java-based access layer. All the user's work is stored in the repository, e.g., source definitions, target definitions, and source-to-target mappings. The repository is based on the Common Warehouse Model (CWM) standard, which makes the Warehouse Builder metadata accessible to other products that support this standard.

Graphical User Interface

The front-end for logging on to the repository features graphical editors and extensive use of wizards. It has been entirely written in Java, making the product highly portable and available for both the Windows and UNIX platforms.

Code Generator

The Warehouse Builder code generator is written in Java. Based on the definitions in the repository it generates the code to implement the warehouse.

Integrators

Integrators are components that are dedicated to extracting data from a particular type of source. The Warehouse Builder Software Development Kit (SDK) is an open interface that allows the user to extend Warehouse Builder's extraction capabilities. Users can build their own integrators that access proprietary data sources, but still tie into the Warehouse Builder framework.

Runtime Auditing

The Warehouse Builder Runtime is a set of tables, sequences, packages and triggers that are installed in the target schema. These database objects are the foundation for Warehouse Builder's auditing and error detection/correction capabilities. For example, loads can be restarted based on information stored in the runtime tables. Warehouse Builder also includes a runtime viewer for browsing of the runtime tables, and runtime reports.

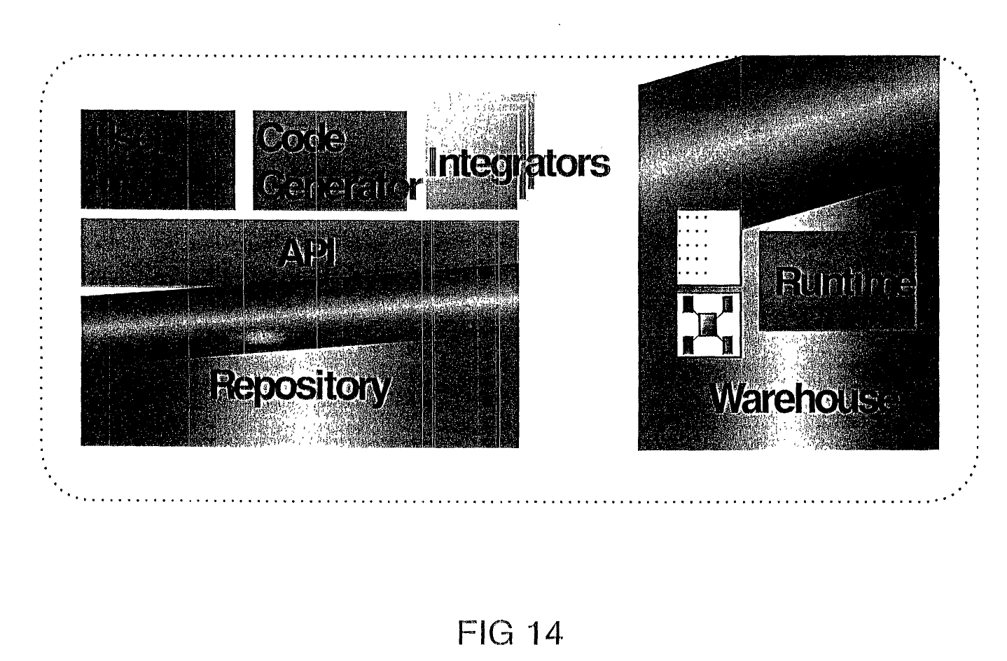

The Oracle Warehouse Builder Architecture is illustrated in FIG. 14.

Software Components

The Software components of the Channel Hub Network include:

1. Oracle iStore

2. Oracle Portal (WebDB)

3. Oracle iPayment

4. Oracle EDI Gateway

5. Oracle E-mail Center

6. External Email Hosting Service Integration

7. Oracle Contracts Core

8. Oracle Customer Loyalty

9. Oracle Warehouse Builder

10. Oracle Order Management

11. Oracle General Ledger

12. Oracle Account Payable

13. Oracle Account Receivable

14. Oracle Inventory

15. Oracle iMarketing

16. Oracle Marketing Online

17. Oracle Support

18. Oracle iSupport

19. Oracle Customer Care

20. LivePerson Integration

21. Oracle ClickStream

22. Oracle Financial Analyzer

23. Oracle Discoverer

24. Oracle 8i with Intermedia and Workflow

25. Oracle Internet Application Server

26. Oracle Internet Developer Suite

Environments

The different environments required for implementation include:

1. Demo

2. Test

3. Development

4. QA

5. Production

Thus, it is seen that the objects of the invention are efficiently obtained, although changes and modifications to the invention should be readily apparent to those having ordinary skill in the art, and these changes and modifications are intended to be within the spirit and scope of the present invention as claimed.

What we claim is:

1. A method for marketing in the wine/spirits industry, comprising:
receiving an offer from at least one wine/spirit suppliers to pay for a solicitation to at least one identified consumer of a participating retail wine/spirit establishment for a selected set of products;
communicating a set of possible product offerings from said at least one wine/spirit suppliers to at least one of said participating retailers of wine/spirits, where each said set includes a number of products;
receiving a communication from at least one said participating retailer agreeing to offer a subset of said set of product offerings at a sale price;
analyzing information related to said subset of said set of product offerings with a computer; and,
communicating said information related to said sales of said subset of said set of product offerings to an interested party.

2. The method as recited in claim 1 wherein said interested party is a supplier of wine/spirits.

3. The method as recited in claim 1 wherein said interested party is a wholesaler of wine/spirits.

4. The method as recited in claim 1 wherein said interested party is a participating retailer of wine/spirits.

5. The method as recited in claim 1 wherein information related to said subset of said set of product offerings is selected from the group consisting of inventory information, sales information, retail customer profile, product profile, geographic profile, ranking of acceptance of the subset of sales offers, discounts, display locations, advertising, sales personnel, retailer profile, wholesaler profile, supplier profile, retail store mapping, promotional profile, and communication efficacy.

6. A method for marketing in the wine/spirits industry, comprising:
communicating a set of possible product offerings to a channel hub for communication to at least one of said participating retailers of wine/spirits, where each said set includes a number of products;
receiving a communication from said hub that at least one said participating retailer agrees to offer a subset of said set of product offerings at a sale price; and,
analyzing information provided to said hub from said participating retailer related to said subset of said set of product offerings with a computer.

7. The method as recited in claim 6 wherein said information related to said subset of said set of product offerings is selected from the group consisting of retail customer profile, retail inventory information, retail sales transaction information, advertising, wholesaler performance information, retailer performance information, promotional performance information, promotional profile information and geographic profile information.

8. A method for marketing in the wine/spirits industry, comprising:
receiving a set of possible product offerings from a channel hub intended for at least one participating retailer of wine/spirits, where each said set includes a number of products;
promoting a subset of said set of product offerings to said at least one said participating retailer; and,
receiving a communication from said channel hub that at least one of at least one said participating retailer agrees to offer a subset of said set of product offerings at a sale price; and,
analyzing information provided to said hub from said participating retailer related to said subset of said set of product offerings with a computer.

9. The method as recited in claim 8 wherein said information related to said subset of said set of product offerings is selected from the group consisting of retail customer profile, retail inventory information, retail sales transaction information, advertising, supplier performance information, retailer performance information, promotional performance information, promotional profile information and geographic profile information.

10. A method for marketing in the wine/spirits industry, comprising:
receiving an offer sent by a channel hub for a selected set of products provided by a supplier of wine/spirits;
selecting a subset of said selected set of products to offer for sale to retail consumers at a sale price, where each said subset includes a number of products;
communicating said selected subset of said selected set of products to said channel hub; and,
analyzing information related to said subset of said set of product offerings with a computer.

11. The method as recited in claim 10 wherein said information related to said subset of said set of product offerings is selected from the group consisting of retail customer profile, product profile, geographic profile, ranking of acceptance of the subset of sales offers, discounts, display locations, advertising, sales personnel, retailer profile, wholesaler profile, supplier profile, promotional performance information, promotional profile, retail store mapping, and communication efficacy.

12. A method of communication in the wine/spirit industry, comprising transmission of a customized promotional offer created at least in part by a computer, from a channel hub directly to consumers of retail wine/spirit establishments, where said transmission is paid for by a supplier of wine/spirits.

13. A method of communication as recited in claim 12 wherein said transmission is made over a global information network.
